(19) United States
(12) Patent Application Publication
(10) Pub. No.: US 2012/0175142 A1
(43) Pub. Date: Jul. 12, 2012

(54) POWER TOOL

(75) Inventors: Benjamin L. Van Der Linde, Braeside (AU); Paul F. Connor, Braeside (AU)

(73) Assignee: DEMAIN TECHNOLOGY PTY LTD., Braeside ,Victoria (AU)

(21) Appl. No.: 13/384,535

(22) PCT Filed: Jul. 15, 2010
(86) PCT No.: PCT/AU2010/000903

§ 371 Date: Mar. 29, 2012

(30) Foreign Application Priority Data
Jul. 17, 2009 (AU) 2009903404

(51) Int. Cl. B23B 45/16; B25F 5/00; B23B 47/14

(52) U.S. Cl. 173/181; 173/47; 173/48

(57) ABSTRACT

The invention provides a transmission assembly and a power tool. One form of the power tool includes a rotatable driven member for releasably gripping and rotating a working element and a transmission assembly for transmitting rotation from a motor to the driven member. The transmission assembly includes a rotatable input shaft and first and second rotatable output shafts. In a first speed setting the input shaft is selectively lockable together with the first output shaft so that the locked input shaft and first output shaft rotate in unison to drive rotation of the driven member at a first speed of rotation relative to a speed of rotation of the motor. In a second speed setting the input shaft is selectively lockable to the second output shaft so that the locked input shaft and second output shaft rotate in unison to drive rotation of the driven member at a second speed of rotation relative to the speed of rotation of the motor. Another form includes a torque controller operable for controlling torque supplied from the motor to the driven member to render the driven member stationary when the amount of torque supplied from the motor to the driven member exceeds a pre-determined level. Another form includes a switch mechanism for adjusting the transmission assembly between the first and second speed settings and for rendering the torque controller operable or inoperable. Another form includes a torque controller for use with a power tool and operable for controlling torque transmitted from an input shaft to an output shaft.

### FIELD OF THE INVENTION

The present invention relates to the field of power tools. The present invention has particular application in respect of power drills and in particular power drills including a motor powered by alternating current. However, it is to be appreciated that the present invention may have broader application than in respect of such power tools.

### BACKGROUND OF THE INVENTION

The existing power drills incorporating a motor powered by alternating current are typically used in applications where high speed operation of a working element is required such as for drilling through masonry and other hard work pieces. Such power drills typically incorporate a rotatable driven member in the form of a chuck which incorporates a set of gripping jaws for releasably gripping and holding a working element such as a drill bit. The driven member is operably coupled to the alternating current powered motor such that when the power tool is activated the motor drives rotation of the driven member which when gripping a working element in turn causes rotation of the working element. When the working element is applied to a work piece the rotation thereof causes the working element to perform work on the work piece.

Existing alternating current powered power tools, such as power drills, can include a chuck which requires a chuck release tool to manually open and close the jaws of the chuck to grip and release a working element from between the jaws. Such power tools also can include only a single speed transmission assembly which does not provide for the ability to operate the drill in anything other than a high speed mode. Furthermore, such power tools can also involve direct driving engagement from the motor to the driven member such that if the driven member becomes jammed as a result of the working element becoming jammed in a work piece the resulting force transferred the power tool can result in either the power tool coming out of a user's hands, breaking the working element or breaking part of the transmission assembly joining the motor to the driven member or otherwise can result in the armature within the motor coming to a standstill which can result in the motor burning out or at least can result in shortening the life of the motor.

### SUMMARY OF THE INVENTION

Accordingly, the present invention seeks to ameliorate some or all of the drawbacks associated with the existing power tools by providing, in one aspect, a power tool including:
a power tool body;
a rotatable driven member for releasably gripping and rotating a working element;
an alternating current powered motor which drives the rotation of the driven member;
a transmission assembly for transmitting rotation from the motor to the driven member and having a first speed setting in which the driven member rotates at a first speed of rotation relative to a speed of rotation of the motor and a second speed setting in which the driven member rotates at a second speed of rotation relative to the speed of rotation of the motor;
a torque controller being operable to control torque supplied by the motor to the driven member to render the driven member stationary when the amount of torque supplied by the motor to the driven member exceeds a pre-determined level.

The invention is advantageous in that it provides a power tool, such as a power drill, which incorporates an alternating current powered motor which can drive rotation of the driven member, or chuck, at speeds that are higher than those achievable by direct current motor driven power tools. The power tool also includes a driven member, or chuck, which can be adjusted to grip and release a working element without requiring manual adjustment of the driven member such as by way of a chuck release tool. The invention is also advantageous in that it provides at least two speed settings, such as high and low speed settings, whereby the driven member, or chuck, is capable of being driven at two different speeds relative to a given speed of rotation of the motor. Furthermore, by providing a torque controller which is capable of controlling the amount of torque supplied by the motor to the driven member the invention is advantageous over power tools which offer only direct driving engagement from the motor to the driven member. By providing a torque controller the invention can avoid breakage of components or of working elements and can extend the life of the motor by ameliorating instances in which the armature within the motor comes to a standstill. The torque controller is also advantageous for screw driving and bolt or nut tightening as it facilitates control of the amount of torque applied to a screw, bolt or nut. Controlling the amount of torque applied to a screw, bolt or nut helps facilitate control of the depth to which a screw is screwed into a workpiece, helps to avoid splitting the workpiece and stripping of the nut or bolt.

In one form, the transmission assembly includes a rotatable input shaft and a rotatable output shaft, rotation of the input shaft is directly driven by the motor and rotation of the driven member is directly driven by the output shaft, wherein in the first and second speed settings the output shaft rotates at respective first and second speeds of rotation relative to a speed of rotation of the input shaft.

In another form, rotation of the output shaft directly drives rotation of the driven member so that rotation of the output shaft at the first and second speeds respectively drive the rotation of the driven member at the first and second speeds of rotation.

In yet another form, first and second coaxial input gears are concentrically mounted on the input shaft and first and second coaxial output gears are concentrically mounted on the output shaft, wherein the first and second input gears are configured for meshing engagement with the first and second output gears respectively.

In one form, respective ones of the first and second speed settings one of the input gears is locked to the input shaft and the other one of the input gears is unlocked from the input shaft such that only rotation of the locked input gear is driven by the motor which in turn drives rotation of a respective one of the output gears.

In another form, in the first and second speed settings the first input gear is in constant meshing engagement with the first output gear and the second input gear is in constant meshing engagement with the second output gear.

In yet another form, the output shaft and the driven member have coaxial axes of rotation.

The transmission assembly is advantageous in that it provides a compact mechanism which provides for at least two speed settings of the power tool. The transmission assembly is also advantageous in that it transmits rotation from the motor to the driven member and provides the at least two speed settings by way of shafts which rotate about only two discreet axes of rotation and does not require a planetary transmission assembly of ring gears, planetary gears and sun gears.

In one form of the power tool, the torque controller includes a pair of opposing rotatable interlocking members which are biased towards each other to interlock when torque supplied by the motor to the driven member is less than the pre-determined level and to rotate relative to each other when the torque supplied by the motor to the driven member is greater than the pre-determined level.

The opposing interlocking surfaces can each include successive ridges and grooves wherein the ridges and grooves of one of the surfaces respectively interlock with the grooves and ridges of the other one of the surfaces.

In one form, the interlocking members are biased by a force which is adjustable to thereby adjust the pre-determined level of torque.

In another form, the torque controller is only operable in the one of the first and second speed settings.

In another form of the power tool, the driven member includes a drive mode and an adjustment mode, in the drive mode rotation of the driven member driven by the motor causes rotation of a working element gripped by the driven member and in the adjustment mode rotation of the driven member driven by the motor causes the driven member to grip or release the working element.

Another form of the power tool further includes an adjustment mechanism for adjusting the driven member between the modes, the adjustment mechanism including first and second engagement portions that move into engagement with each other to thereby adjust the driven member to the adjustment mode and move out of engagement to thereby adjust the driven member to the drive mode.

In one form, the first engagement portion is rotatable and the second engagement portion is not rotatable so that engagement between the first and second engagement portions prevents rotation of the first engagement portion.

In another form, the first engagement portion is connected to a first threaded component which is in engagement with a second threaded component such that rotation of the second threaded component when the first engagement portion is prevented from rotating results in rotation of the first and second threaded components relative to each other and translational motion of the second threaded component.

In yet another form, the second threaded component is a set of jaws for gripping the working element and the jaws are configured for translational motion towards each other to grip the working element and away from each other to release the working element.

In still yet another form, the torque controller is selectively operable or inoperable and the power tool further includes a switch mechanism for adjusting the transmission assembly between the first and second speed settings and for selecting between the operable and inoperable conditions of the torque controller.

In one form, the switch is configured to adjust the transmission assembly to either the first or second speed setting when the torque controller is inoperable and to only one of the first and second speed settings when the torque controller is operable.

In another form, the driven member includes a drive mode and an adjustment mode, in the drive mode rotation of the driven member driven by the motor causes rotation of a working element gripped by the driven member and in the adjustment mode rotation of the driven member driven by the motor causes the driven member to grip or release the working element.

In one form, the power tool further includes an adjustment mechanism for adjusting the driven member between the modes, the adjustment mechanism including first and second engagement portions that move into engagement with each other to thereby adjust the driven member to the adjustment mode and move out of engagement to thereby adjust the driven member to the drive mode.

In one form, the first engagement portion is rotatable and the second engagement portion is not rotatable so that engagement between the first and second engagement portions prevents rotation of the first engagement portion.

In another form, the first engagement portion is connected to a first threaded component which is in engagement with a second threaded component such that rotation of the second threaded component when the first engagement portion is prevented from rotating results in rotation of the first and second threaded components relative to each other and translational motion of the second threaded component.

In yet another form, the second threaded component is a set of jaws for gripping the working element and the jaws are configured for translational motion towards each other to grip the working element and away from each other to release the working element.

The power tool can further include a switch mechanism for adjusting the transmission assembly between the first and second speed settings and for adjusting the driven member between the adjustment and drive modes.

In one for, the switch is configured to adjust the transmission assembly to either the first or second speed setting when the driven member is in the drive mode and to only one of the first and second speed settings when the driven member is in the adjustment mode

In another form, the power tool further includes a hammer mechanism which can be engaged or disengaged, wherein when the hammer mechanism is engaged and rotation of the driven member is driven by the motor the driven member is displaced back and forth longitudinally along an axis of rotation of the driven member.

In another aspect, the invention provides a power tool including:
a rotatable driven member for releasably gripping and rotating a working element;
a transmission assembly for transmitting rotation from a motor to the driven member, the transmission assembly including a rotatable input shaft and first and second rotatable output shafts,
in a first speed setting the input shaft is selectively lockable together with the first output shaft so that the locked input shaft and first output shaft rotate in unison to drive rotation of the driven member at a first speed of rotation relative to a speed of rotation of the motor, and
in a second speed setting the input shaft is selectively lockable to the second output shaft so that the locked input shaft and second output shaft rotate in unison to drive rotation of the driven member at a second speed of rotation relative to the speed of rotation of the motor.
a torque controller operable for controlling torque supplied from the motor to the driven member to render the driven member stationary when the amount of torque supplied from the motor to the driven member exceeds a pre-determined level, and
a switch mechanism for adjusting the transmission assembly between the first and second speed settings and for rendering the torque controller operable or inoperable.

In one form, the switch is operable for adjusting the transmission assembly between the first and second speed settings and for selecting between the operable and inoperable conditions of the torque controller in only one of the speed settings of the transmission assembly.

In another form, the driven member includes a drive mode and an adjustment mode, in the drive mode rotation of the driven member causes rotation of a working element gripped by the driven member and in the adjustment mode rotation of the driven member driven by the motor causes the driven member to grip or release the working element,

In another form, the switch is configured to adjust the transmission assembly to either the first or second speed setting when the driven member is in the drive mode and to only one of the first or second speed setting when the driven member is in the adjustment mode.

In one form, the power tool further includes a manual adjustment device for adjusting the pre-determined level of torque between a plurality of settings wherein at least one setting facilitates adjustment of the driven member by the switch to the adjustment mode and at least one setting prevents adjustment of the driven member by the switch to the adjustment mode and maintains the driven member in the drive mode.

In another form, the power tool further includes a hammer mechanism which can be engaged or disengaged, wherein when the hammer mechanism is engaged and rotation of the driven member is driven by the motor the driven member is displaced back and forth longitudinally along an axis of rotation of the driven member.

In one form, the motor is an alternating current powered motor.

In another aspect, the invention provides a transmission assembly for use with a power tool including a rotatable driven member driven by a motor, the assembly including a rotatable input shaft and first and second rotatable output shafts,
in a first speed setting the input shaft is selectively lockable together with the first output shaft so that the locked input shaft and first output shaft rotate in unison to drive rotation of a driven member at a first speed of rotation relative to a speed of rotation of the motor, and
in a second speed setting the input shaft is selectively lockable to the second output shaft so that the locked input shaft and second output shaft rotate in unison to drive rotation of the driven member at a second speed of rotation relative to the speed of rotation of the motor.

In one form, the first output shaft includes a first output locking member, the second output shaft includes a second output locking member and the input shaft includes an input locking member, the output locking members are positioned adjacent each other and the input locking member is positioned concentrically around the output locking members so that the output locking members and the input locking member are coaxial, wherein the input locking member is selectively lockable together with either one of the output locking members.

In another form, a selection member is positioned concentrically around the output locking member and is movable in the direction of an axis of rotation of the output locking members and the input locking member between a first position in which the selection member locks the input locking member together with the first output locking member of the first output shaft, and a second position in which the selection member locks the input locking member together with the second output locking member of the second output shaft.

In yet another form, one of the output shafts is positioned concentrically around at least a portion of the other one of the output shafts.

In still yet another form, the input shaft and the first and second output shafts have a common axis of rotation.

In one form, the transmission assembly further includes a rotatable drive shaft which transmits rotation from one of the first and second rotatable output shafts to the driven member, wherein rotation of the drive shaft is directly driven by the first output shaft when the transmission is in the first speed setting and by the second output shaft when the transmission is in the second speed setting.

In another form, the first and second output shafts respectively include first and second output gears and the drive shaft includes first and second drive shaft gears, wherein the first and second output gears are in constant meshing engagement with the first and second drive shaft gears respectively.

In yet another form, the input shaft and the first and second output shafts have a common axis of rotation that is parallel to an axis of rotation of the drive shaft.

In another aspect, the invention provides a switch mechanism for use in a device, the switch including a manually operated selector with three successive positions, wherein when the selector is in a first position a first actuator is biased towards a first position of the first actuator and a second actuator is biased towards a first position of the second actuator, when the selector is in a second position the first actuator is biased towards a second position of the first actuator and the second actuator is biased towards the first position of the second actuator, and when the selector is in a third position the first actuator is biased towards the second position of the first actuator and the second actuator is biased towards a second position of the second actuator.

In one form, movement of the selector between the first, second and third positions causes biased translation of the first and second actuators between their respective first and second positions.

In another form, when the first and second actuators are biased towards and reach either of their first and second positions the first and second actuators are locked in their respective first and second positions.

In another aspect, the invention provides a torque controller for use with a power tool and operable for controlling torque transmitted from an input shaft to an output shaft, the torque controller including:
a pair of opposing rotatable interlocking members which are respectively mounted to one of the input and output shafts,
the opposing rotatable interlocking members are biased towards each other with a force that causes the interlocking members to interlock when torque supplied by the motor to the driven member is less than the pre-determined level and to rotate relative to each other when the torque supplied by the motor to the driven member is greater than the pre-determined level,
a mechanism for selectively rotatably locking and unlocking one of the interlocking members to one of the shafts for rendering the torque controller operable and inoperable respectively,
the mechanism including an intermediate member between the interlocking member and the shaft, wherein the intermediate member and the interlocking member are substantially rotatably locked together but are able to move longitudinally relative to each other in the direction of the axis of rotation.

In one form, the intermediate member is mounted to the shaft so as to be unable to move longitudinally relative to the shaft along the axis of rotation, and the interlocking member is mounted to the shaft so as to be able to move longitudinally relative to the shaft along the axis of rotation between a position interlocking with the other one of the interlocking members and a position not interlocking with the other one of the interlocking members in which the interlocking members are able to rotate relative to each other.

In another form, the intermediate member includes a slot with an opening extending longitudinally in the direction of the axis of rotation for receiving a projection of the interlocking member, the slot having a pair of opposing lateral sides for abutment with the projection to substantially prevent relative rotation of the intermediate member and the interlocking member, wherein longitudinal movement of the projection within opening of the slot enables the longitudinal movement of the intermediate member relative to the interlocking member in the direction of the axis of rotation.

In yet another form, the slot and the projection each have a substantially tapered profile and have substantially identical dimensions.

In still yet another form, the opposing interlocking members each include successive ridges and grooves wherein the ridges and grooves of one of the surfaces respectively interlock with the grooves and ridges of the other one of the members.

In one form, the force biasing the interlocking members is adjustable so as to adjust the pre-determined level of torque.

In one form, the torque controller further includes a locking member rotatably fixed to the shaft and the intermediate member including an opening for receiving the locking member, wherein the locking member is configured to move longitudinally in alternate directions along the axis of rotation between a position in which the locking member is received within the opening and rotatably locks the intermediate member to the shaft and a position in which the locking member is not received within the opening and does not rotatably lock the intermediate member to the shaft.

In one form, the intermediate member and the interlocking member include frictional contacting surfaces that provide frictional contact between the intermediate member and the interlocking member while the intermediate member and the interlocking member move longitudinally relative to each other in the direction of the axis of rotation.

Further aspects and concepts will become apparent to those skilled in the art after considering the following description and claims in conjunction with the accompanying drawings.

### BRIEF DESCRIPTION OF THE DRAWINGS

In the accompanying drawings, which are incorporated in and constitute a part of the specification, embodiments of the invention are illustrated, which together with a general description of the invention given above, and the detailed description below, serve to exemplify embodiments of the invention.

FIG. 1 is a perspective view of a power tool in accordance with an embodiment of the invention including a housing containing components of the power tool.

FIG. 2 is a perspective view of the power tool of FIG. 1 wherein portions of the housing have been removed to illustrate internal components of the power tool including a driven member, a transmission assembly, a torque control mechanism, a switch and a motor.

FIG. 3 is an exploded view of a first assembly of the transmission assembly.

FIG. 4 is an exploded view of a second assembly of the transmission assembly and of the torque control mechanism as well as the assembled driven member.

FIG. 5 is a perspective view of the power tool of FIG. 1 illustrating a selection dial of the switch and an adjustment ring of the torque control mechanism, wherein the selection dial is in a first one of three positions in which the transmission assembly is in a first of two speed settings, the torque control mechanism is engaged and wherein the adjustment ring is in a position in which the driven member is in an adjustment mode.

FIG. 6 is a side view of a cross section of the power tool of FIG. 1 taken along the section line B-B of FIG. 5 illustrating the transmission assembly in the first of two speed settings, the torque control mechanism being engaged and the driven member is in the adjustment mode.

FIG. 7 is a perspective view of the power tool of FIG. 1 illustrating the selection dial of the switch in the first one of three positions in which the transmission assembly is in a first of two speed settings, the torque control mechanism is engaged and wherein the adjustment ring is in a position in which the driven member is in a drive mode.

FIG. 8 is a side view of a cross section of the power tool of FIG. 1 taken along the section line C-C of FIG. 7 illustrating the transmission assembly in the first of two speed settings, the torque control mechanism being engaged and the driven member is in the drive mode.

FIG. 9 is a perspective view of the power tool of FIG. 1 illustrating the selection dial of the switch in a second one of three positions in which the transmission assembly is in a first of two speed settings, the torque control mechanism is disengaged and wherein the adjustment ring is in a position in which the driven member is in a drive mode.

FIG. 10 is a side view of a cross section of the power tool of FIG. 1 taken along the section line D-D of FIG. 9 illustrating the transmission assembly in the first of two speed settings, the torque control mechanism being disengaged and the driven member is in the drive mode.

FIG. 11 is a perspective view of the transmission assembly and part of the torque control mechanism of the power tool of FIG. 1, the transmission assembly including a first shaft and a second shaft and being operable for transmitting rotation from the motor to the driven member and having a first speed setting in which the driven member rotates at a first speed of rotation relative to a speed of rotation of the motor and a second speed setting in which the driven member rotates at a second speed of rotation relative to the speed of rotation of the motor.

FIG. 12 is a perspective view of the transmission assembly of FIG. 11 wherein a torque tube has been removed from the first shaft to uncover first and second castellated sleeves and to illustrate the way in which radially inwardly projecting legs of a gear selection ring cooperate with grooves associated with the first and second castellated sleeves in order to engage first and second speed settings of the transmission assembly.

FIG. 13 is a side view of a cross section of the transmission assembly of FIG. 11 taken along the section lines E-E and F-F in FIG. 11 wherein the radially inwardly projecting legs of the gear selection ring cooperate with grooves associated with the first castellated sleeve which corresponds to selection of the first speed setting of the transmission assembly and in which the torque control mechanism is engaged.

FIG. 14 is a side view of a cross section of the transmission assembly of FIG. 11 taken along the section lines E-E and F-F in FIG. 11 wherein the radially inwardly projecting legs of the gear selection ring cooperate with grooves associated with the first castellated sleeve which corresponds to selection of the first speed setting of the transmission assembly and in which the torque control mechanism is disengaged.

FIG. 15 is a side view of a cross section of the transmission assembly of FIG. 11 taken along the section lines E-E and F-F in FIG. 11 wherein the radially inwardly projecting legs of the gear selection ring cooperate with grooves associated with the second castellated sleeve which corresponds to selection of the second speed setting of the transmission assembly and in which the torque control mechanism is disengaged.

FIG. 16 is a bottom view of the gear assembly, driven member and switch of the power tool of FIG. 1 illustrating the connection between the switch and the gear selection ring of the gear assembly.

FIG. 17 is a top view of the gear assembly, driven member and switch of the power tool of FIG. 1 illustrating the connection between the switch and the adjustment mechanism for adjusting the driven member between the drive mode and the adjustment mode.

FIG. 18 is a perspective view of a torque control mechanism in accordance with another embodiment, the torque control mechanism is assembled with some components of the transmission assembly.

FIG. 19 is a side view of a cross section of the torque control mechanism of FIG. 18 taken along the section lines V-V, wherein the locking key is in a position in which the torque control mechanism is rendered inoperable.

FIG. 20 is a side view of a cross section of the torque control mechanism of FIG. 18 taken along the section lines V-V, wherein the locking key is in a position in which the torque control mechanism is rendered operable.

FIG. 21 is an exploded view of the torque control mechanism of FIG. 18 and some components of the transmission to which the torque control mechanism is mounted.

FIG. 22 is a perspective view of components of the torque control mechanism of FIG. 18 in unassembled form, in particular, the second output gear, clutch plate and intermediate member.

### DETAILED DESCRIPTION

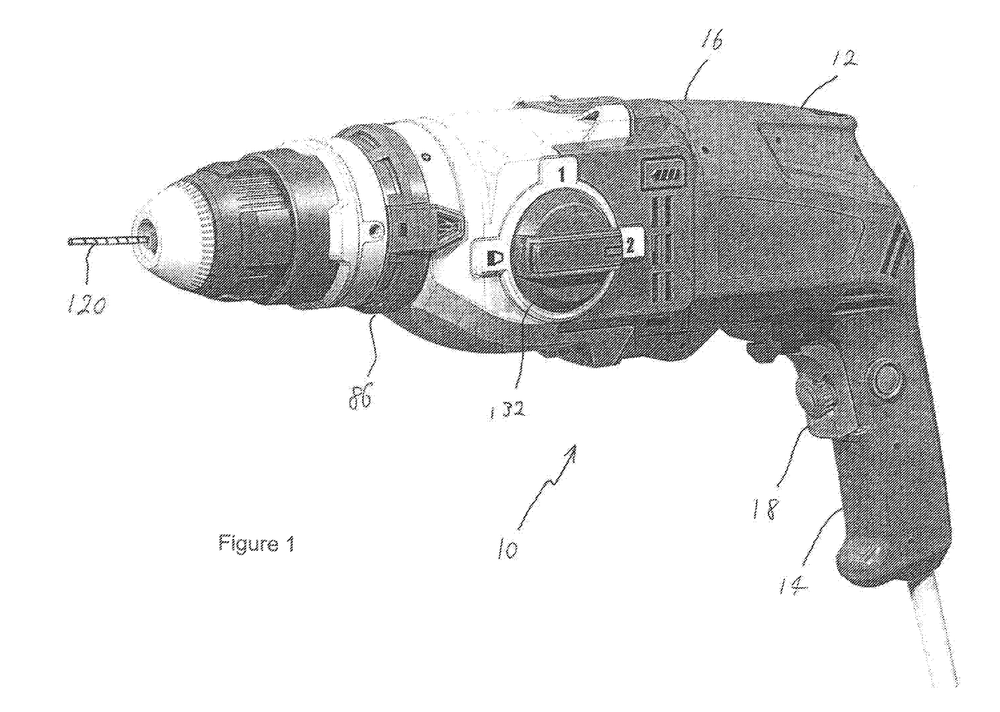

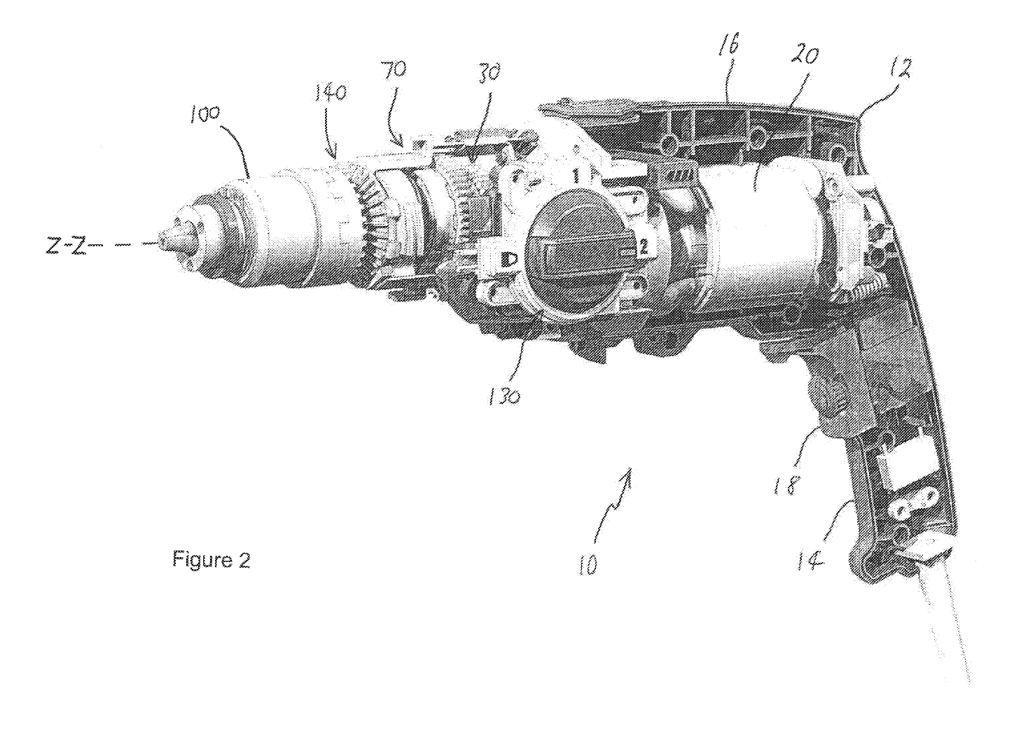

Referring to FIGS. 1 and 2, there is shown a power tool 10 which, in the particular embodiment illustrated, is in the form of a power drill. The power tool 10 includes a housing 12 which contains internal components of the power tool 10. The housing 12 includes a handle portion 14 which is configured for being gripped by a user. The handle 14 is connected to the main body 16 of the housing 12. The body 16 houses a motor 20 which, in a particularly preferred form, is an alternating current powered motor. The motor 20 includes a rotating armature (not shown) which has a portion which protrudes from a forward portion of the motor 20. A helical input gear (not shown) is fixed to the protruding portion of the armature. When the trigger 18 is operated alternating current is supplied from a power source to the motor 20 such that the armature is caused to rotate which in turn causes the helical input gear 27 to also rotate.

Referring to FIG. 2, the power tool 10 includes a rotatable driven member 100 for releasably gripping and rotating a working element 120. In the particular embodiment illustrated the driven member 100 is in the form of a drill chuck and the working element 120 may be a drill bit or a screwdriver bit or some other working element useful for performing work on a work piece. The motor 20 drives the rotation of the driven member 100 via a transmission assembly 30. The transmission assembly 30 has a first speed setting in which the driven member 100 rotates at a first speed of rotation relative to a speed of rotation of the motor 20 and a second speed setting in which the driven member 100 rotates at a second speed of rotation relative to the speed of rotation of the motor 20. The power tool 10 also includes a torque controller or torque control mechanism 70. The terms “torque controller” and “torque control mechanism” are used interchangeably herein. The torque control mechanism 70 can be selectively engaged or disengaged. When the torque control mechanism 70 is engaged it is operable to control torque supplied by the motor 20 to the driven member 100 to render the driven member 100 stationary when the amount of torque supplied by the motor 20 to the driven member 100 exceeds a pre-determined level.

Transmission Assembly

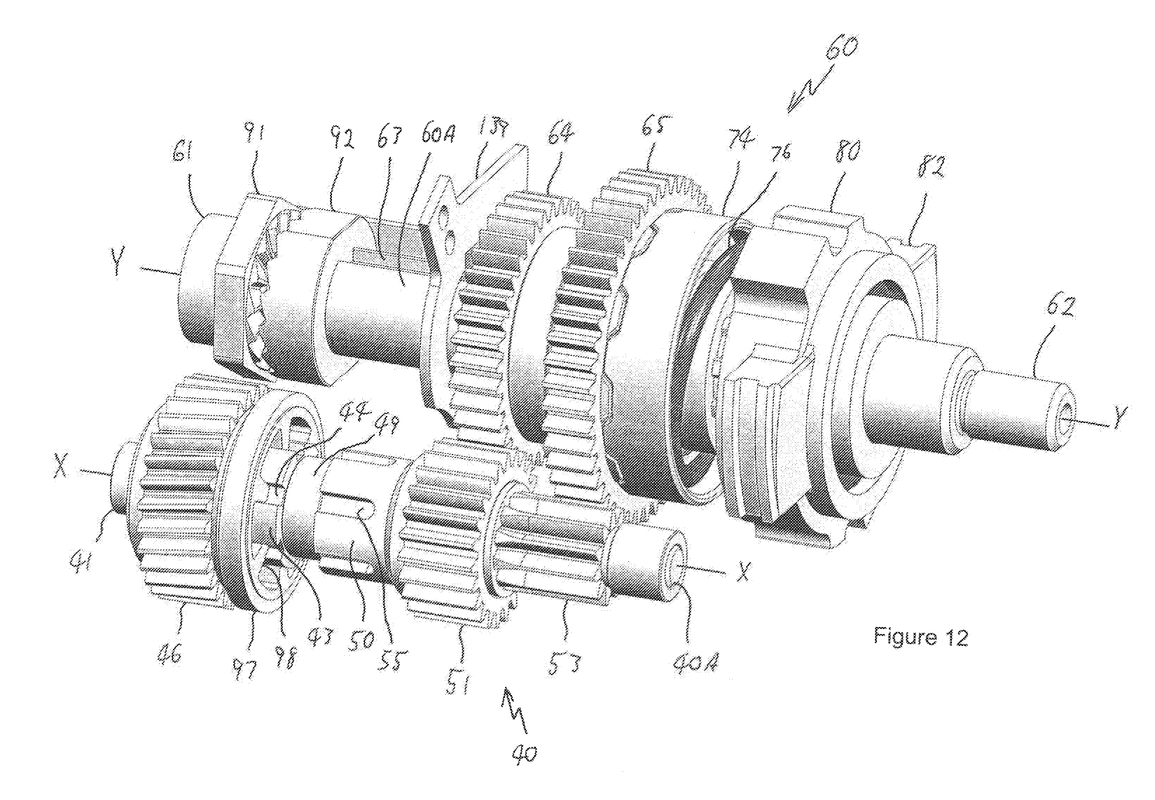

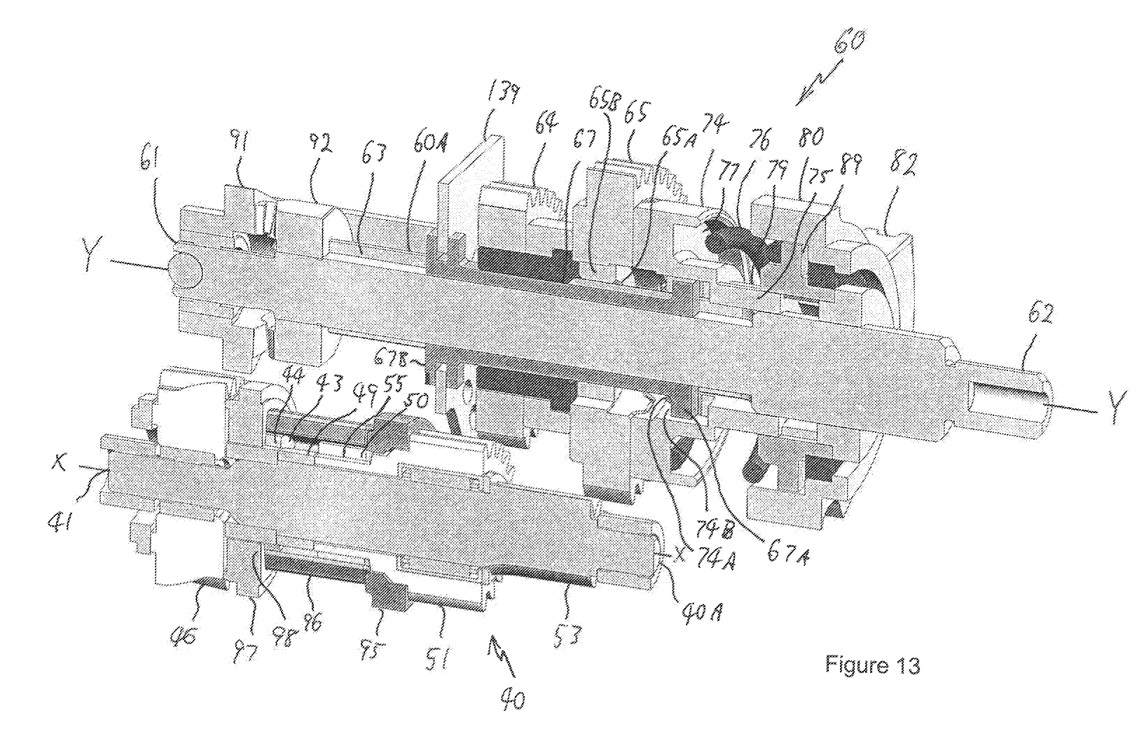

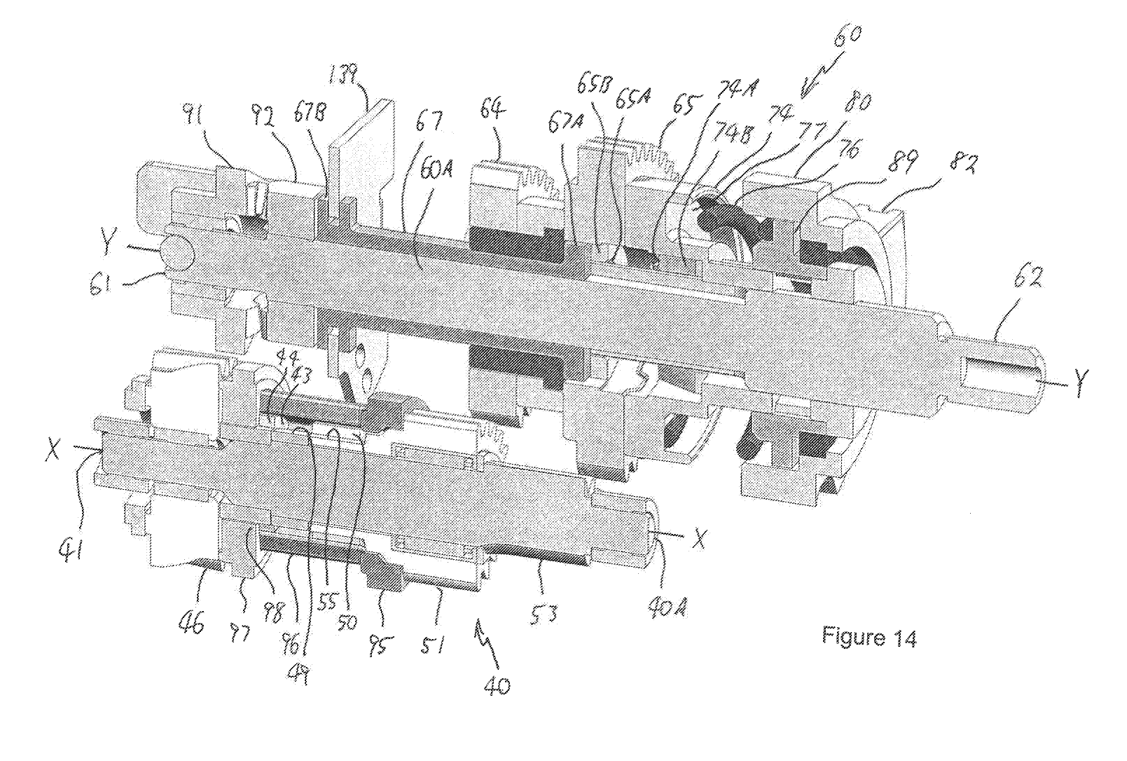

Referring to FIGS. 2 to 4, the transmission assembly 30 is housed within the body 16 of the power tool 10. As can be seen in FIGS. 2 to 4 and 11 to 15, the transmission assembly 30 includes a first assembly 40 and a second assembly 60. The first assembly 40 of the transmission assembly 30 is cooperable with the second assembly 60 in a manner described in detail below. The first and second assemblies 40, 60 have respective longitudinal axes X-X and Y-Y. The longitudinal axes X-X and Y-Y of the first and second assemblies 40, 60 are spaced apart and parallel to each other such that they both are oriented in substantially the same direction. The first and second assemblies 40, 60 are configured to transmit rotation of the armature of the motor 20 into rotation of the driven member 100 in the manner described herein.

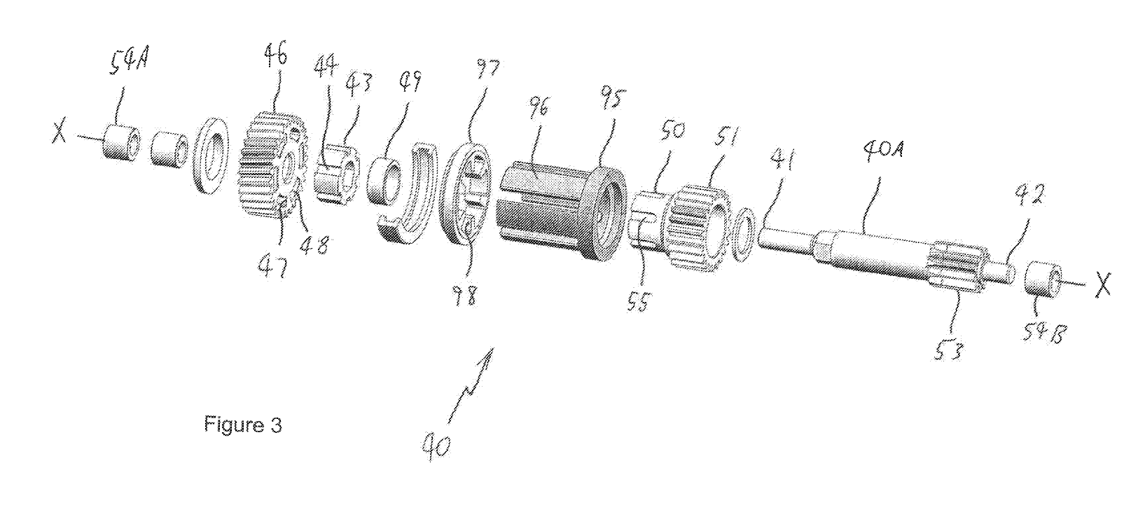

Referring to FIG. 3, the first assembly 40 includes an axle 40A having a first end 41 and a second end 42. The axle 40A extends longitudinally between the first and second ends 41, 42 and is coaxial with the axis X-X. The first assembly 40 is supported within the body 16 of the power tool 10 by a first bearing mount 54A which is arranged concentrically around the first end 41 of the axle 40A and a second bearing mount 54B which is arranged concentrically around the second end 42 of the axle 40A.

The first assembly 40 includes a rotatable input shaft A, a rotatable first output shaft B and a rotatable second output shaft C arranged coaxially located along the axle 40A from the first end 41 to the second end 42.

The rotatable input shaft A includes a helical gear 46 and an input locking member in the form of a torque tube 95. The helical gear 46 includes a plurality of radially inwardly extending projections 47. Between adjacent pairs of the projections within the helical gear 46 are a plurality of apertures 48. The torque tube 95 includes a plurality of legs 96 which extend in the direction of the axis X-X and fit into and lock within the apertures 48 within the helical gear 46. As the helical gear 46 rotates about the axis X-X the torque tube 95, which has its legs 96 locked to the helical gear 46, also rotates in unison with the helical gear 46. The helical gear 46 is configured for meshing engagement with the helical input gear (not shown) attached to the armature (not shown) of the motor 20.

The rotatable first output shaft B includes a first output locking member in the form of a first castellated sleeve 43 immediately adjacent the helical output gear 46. The first castellated sleeve 43 is keyed to the axle 40A such that the sleeve 43 and the axle 40A rotate in unison about the axis X-X. The axle 40A is also integrally formed with a first output pinion gear 53 which is immediately adjacent to the second end 42 of the axle 40A. Thus, the first castellated sleeve 43, the axle 40A and the first output pinion gear 53 all are effectively locked together such that they all rotate together in unison.

The rotatable second output shaft C includes a second output locking member in the form of a second castellated sleeve 50 integrally formed with a second output pinion gear 51. The second castellated sleeve 50 and the second output pinion gear 51 are arranged concentrically around the axle 40A and are rotatable about the axis X-X independently of the axle 40A. Between the first castellated sleeve 43 and the second castellated sleeve 50 is a spacing ring 49 that is also arranged concentrically around the axle 40A and bridges a gap between the first castellated sleeve 43 and a second castellated sleeve 50.

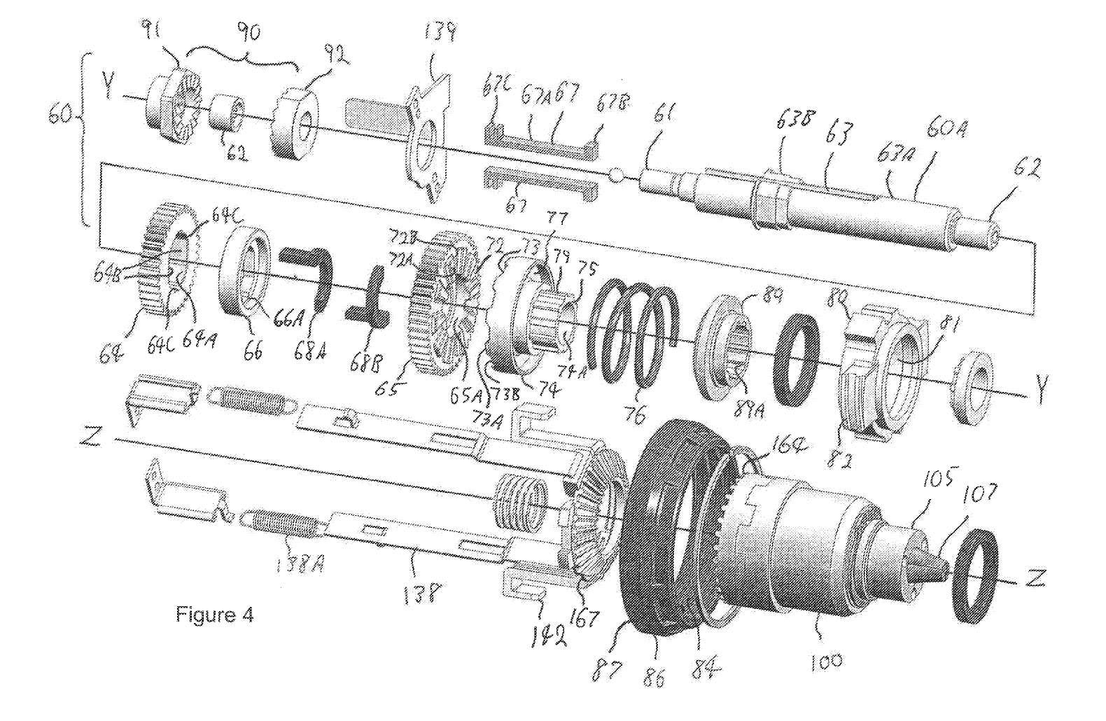

Referring to FIG. 4, the second assembly 60 includes an elongate drive shaft 60A which extends longitudinally from a first end 61 to a second end 62 and rotates about the axis Y-Y. The drive shaft 60A includes a longitudinal groove 63 extending in the direction of the axis Y-Y from the first end 61 along a portion of the length of the drive shaft 60A towards the second end 62. A key member 67 having a longitudinal bar portion 67A is positioned within the groove 63 such that the bar portion 67A extends in the direction of the axis Y-Y. The purpose of the longitudinal groove 63 and the key member 67 will be described in detail below. A hammer mechanism 90 is disposed at the first end 61 of the second assembly 60 and includes a first hammer plate 91 and a second hammer plate 92. The function of the hammer mechanism 90 is described in detail below. The first end 61 of the drive shaft 60A is supported by a bearing 62 that is fixed to the first hammer plate 91 which in turn is fixed to the body 16 of the power tool 10. The second end 62 of the drive shaft 60A is fixed the driven member 100.

A first output gear 64 is arranged concentrically around the drive shaft 60A in a position along the length of the drive shaft 60A spaced apart from the hammer mechanism 90 in the direction from the first end 61 towards the second end 62 of the drive shaft 60A. A second output gear 65 is positioned adjacent the first output gear 64 with a spacer 66 between the second output gear 65 and the first output gear 64. The second output gear 65 is also positioned concentrically around the drive shaft 60A. The first output gear 64 is fixed to the drive shaft 60A at all times whereas the second output gear 65 is selectively fixable to the drive shaft 60A in a manner described below.

The first output gear 64 includes a central aperture 64A which receives the drive shaft 60A therethrough. The central aperture 64A includes parallel spaced apart surfaces 64B that are keyed to a complimentary shaped portion 63B of the drive shaft 60A. The parallel spaced apart surfaces 64B receive the complimentary shaped portion 63B of the drive shaft 60A to fix the first output gear 64 from rotating relative to the drive shaft 60A. The second output gear 65 also includes a central aperture 65A which receives the drive shaft 60A therethrough. Bushes 68A, 68B are positioned within slots 66A in the spacer 66 and within slots 64C within the central aperture 64A of the first output gear 64. The bushes 68A, 68B are configured to retain the key members 67 within the longitudinal groove 63 of the drive shaft 60A. The second output gear 65 is either able to freely rotate relative to the drive shaft 60A or is selectively lockable to the drive shaft 60A to be fixed from rotating relative to the drive shaft 60A in a manner which will be described below.

A clutch plate 74 is positioned concentrically around the drive shaft 60A immediately adjacent the second output gear 65. The clutch plate 74 includes a central aperture 74A for receiving the drive shaft 60A therethrough. A forward facing first annular clutch surface 72 of the second output gear 65 and a rearward facing second annular clutch surface 73 of the clutch plate 74 cooperate to provide the torque control function of the torque control mechanism 70 in a manner which will be described in more detail below. The clutch plate 74 also includes an integrally attached sleeve portion 75 which is arranged concentrically around the drive shaft 60A and which includes a plurality of radially outwardly extending projections 79.

The function of the first assembly 40 and the second assembly 60 will now be explained with reference to FIGS. 3, 4 and 11 to 15. When the motor 20 is operated the armature and the helical input gear both rotate which in turn causes the helical output gear 46, in meshing engagement with the helical input gear, to also rotate. As the helical output gear 46 rotates about the axis X-X the torque tube 95, which has its legs 96 locked to the helical output gear 46, also rotates in unison with the helical gear 46.

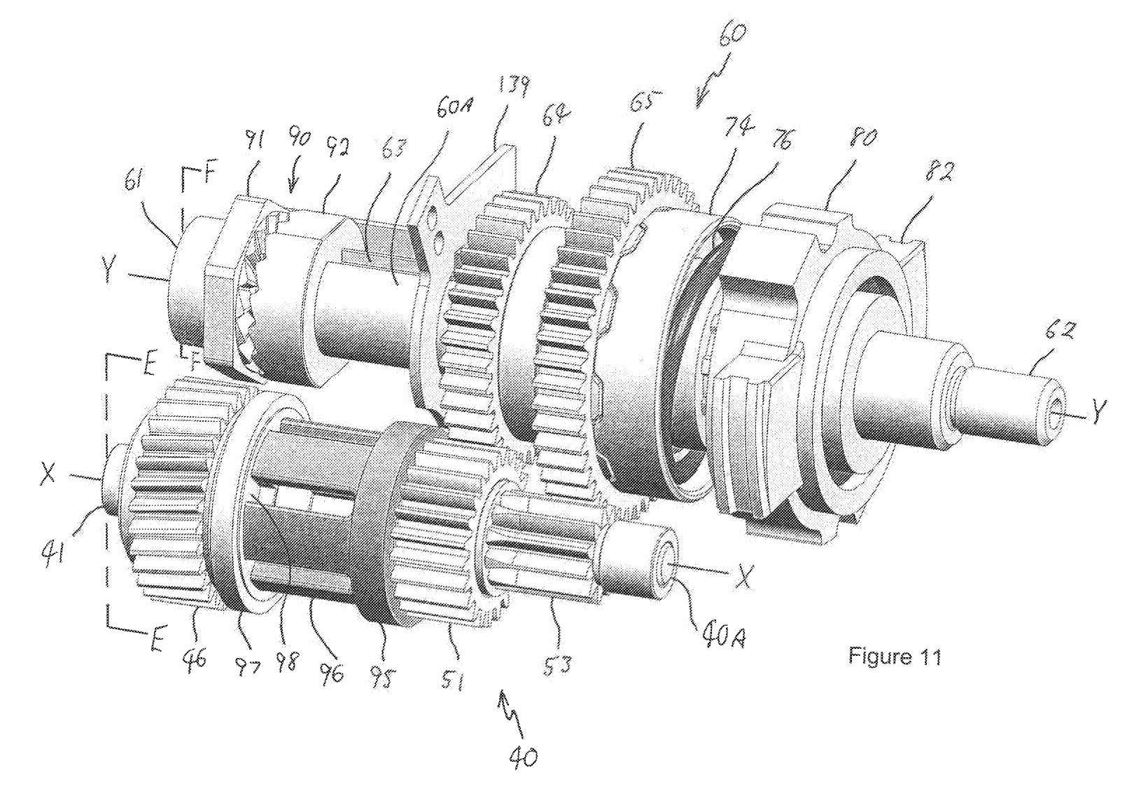

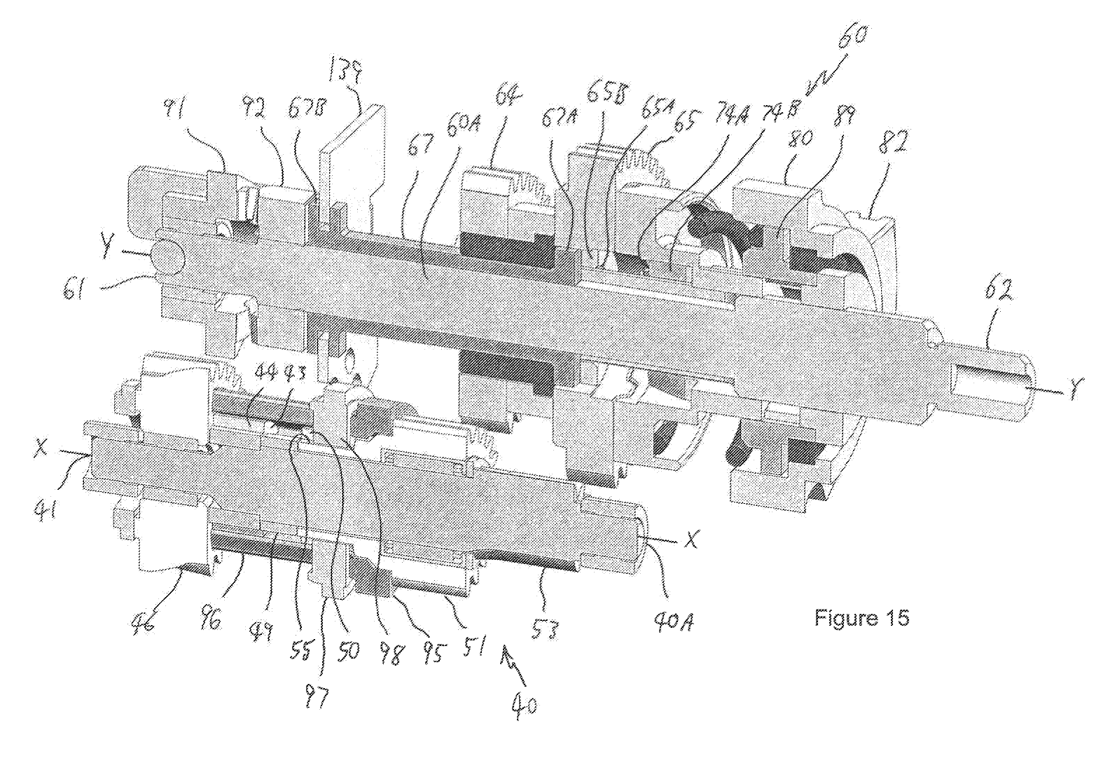

An annular gear selection ring 97 is arranged concentrically around the torque tube 95 and includes a plurality of radially inwardly projecting legs 98 which fit within slots 99 between adjacent pairs of the legs 98 of the torque tube 95. Thus, the gear selection ring 97 rotates in unison with the torque tube 95 and with the helical output gear 46 about the axis X-X. The gear selection ring 97 is slidable relative to the torque tube 95 back and forth along the axis X-X such that the legs 98 locate either: a) within the grooves 44 of the first castellated sleeve 43 when the selection ring 97 is moved in a direction towards the helical output gear 46 as illustrated in FIGS. 11 to 14; or b) within the grooves 55 in the radially outwardly facing surface of the second castellated sleeve 50 when the selection ring 97 is moved in a direction towards the first input pinion gear 51 as illustrated in FIG. 15.

When the legs 98 of the gear selection ring 97 are positioned within the grooves 44 of the first castellated sleeve 43, as illustrated in FIGS. 11 to 14, the gear selection ring 97 locks the first castellated sleeve 43 to the torque tube 95 and the helical output gear 46 resulting in the first castellated sleeve 43 and the helical output gear 46 rotating in unison about the axis X-X. When the legs 98 of the gear selection ring 97 are positioned within the grooves 55 of the second castellated sleeve 50, as illustrated in FIG. 15, the gear selection ring 97 locks the second castellated sleeve 50 to the torque tube 95 and the helical output gear 46 resulting in the second castellated sleeve 50 and the helical output gear 46 rotating in unison about the axis X-X.

When the gear selection ring 97 engages the first castellated sleeve 43 and the motor 20 is activated, the motor 20 drives rotation of the helical output gear 46, which in turn drives rotation of the first castellated sleeve 43. Because the first castellated sleeve 43 is coupled via the axle 40A to the second input pinion gear 53 in such a way that the first castellated sleeve 43 and the second input pinion gear 53 rotate in unison, when the gear selection ring 97 engages the first castellated sleeve 43, activation of the motor 20 drives rotation of the second input pinion gear 53 at the same speed of rotation as the helical output gear 46. The second input pinion gear 53 is in meshing engagement with the second output gear 65 of the second assembly 60. Thus, when the gear selection ring 97 engages the first castellated sleeve 43 this in turn enables the motor 20 to drive rotation of the second output gear 65 via the second input gear 53. Engagement of the first castellated sleeve 43 by the gear selection ring 97, as described above, corresponds to a first speed setting of the power tool 10. In the embodiment illustrated in the Figures, the first speed setting is a low speed setting.

When the gear selection ring 97 engages the second castellated sleeve 50 and the motor 20 is activated, the motor 20 drives rotation of the helical output gear 46, which in turn drives rotation of the second castellated sleeve 50. Because the second castellated sleeve 50 is integrally coupled to the first input pinion gear 51, when the gear selection ring 97 engages the second castellated sleeve 50, activation of the motor 20 drives rotation of the first input pinion gear 51 at the same speed of rotation as the helical output gear 46. The first input pinion gear 51 is in meshing engagement with the first output gear 64 of the second assembly 60. Thus, when the gear selection ring 97 engages the second castellated sleeve 50 this in turn enables the motor 20 to drive rotation of the first output gear 64 via the first input gear 51. Engagement of the second castellated sleeve 50 by the gear selection ring 97, as described above, corresponds to a second speed setting of the power tool 10. In the embodiment illustrated in the Figures, the second speed setting is a high speed setting.

In the first speed setting the drive shaft 60A and the driven member 100, which is fixed to the drive shaft 60A, are caused to rotate at a first speed of rotation relative to given speed of rotation of the armature of the motor 20. In the second speed setting the drive shaft 60A and the driven member 100 are caused to rotate at a second speed of rotation relative to a given speed of rotation of the armature of the motor 20.

Driven Member

Referring to FIGS. 2, 4, 6, 8 and 10, the driven member 100 is a three jaw chuck arrangement that includes a head portion 105 and a plurality of jaws 107 mounted to the head portion 105 in an angular orientation relative to an axis of rotation Z-Z of the driven member 100. The axis of rotation Z-Z of the driven member 100 is coaxial with as the axis of rotation Y-Y of the drive shaft 60A of the transmission assembly 30. Each one of the jaws 107 has a gripping face adapted to clamp against the shank of the working element 120 such as a drill or screwdriver bit. Each jaw 107 is also slidably mounted in the head portion 105 so as to be slidable in a path of movement that is angularly displaced relative to the axis of rotation Z-Z of the driven member 100. The driven member 100 also includes an adjusting nut 108 which has a thread that meshes with a thread on each one of the jaws 107. The head portion 105 is coupled to the drive shaft 60A such that the head portion 105 and the drive shaft 60A rotate in unison. Thus, rotation of the head portion 105 is driven by the motor 20 via the transmission assembly 30. The arrangement of the adjusting nut 108, the jaws, 107 and the head portion 105 are such that rotation of the head portion 105 driven by the motor 20 causes the jaws 107 to rotate about the axis Z-Z.

The driven member 100 has a drive mode and an adjustment mode. The driven member 100 is adjustable between the drive mode and the adjustment mode by an adjustment mechanism 140. The adjustment mechanism 140 includes a first member 164 and a second member 167. The first member 164 has a first engagement portion 165 which is in the form of conically shaped splines and the second member 167 has a second engagement portion 168 also comprised of a set of conically shaped splines. The first member 164 is connected via a sleeve 163 to the adjusting nut 108 and is able to freely rotate with the adjusting nut 108 about the axis Z-Z. The second member 167 is connected to the body 16 of the power tool 10 in such a way that the second member 167 will not rotate about the axis Z-Z but in which the second member 167 is movable towards and away from the first member 164 in the direction of the axis Z-Z. When the second member 167 moves towards the first member 164 the first and second engagement portions 165, 168 and the respective splines thereof respectively inter-engage such that the first member 164, and the adjusting nut 108 are prevented from rotating about the axis Z-Z. This corresponds to the adjustment mode of the driven member 100. When the second member 167 moves away from the first member 164 the first and second engagement portions 165, 168 and the respective splines thereof respectively disengage such that the first member 164, and the adjusting nut 108 may freely rotate about the axis Z-Z. This corresponds to the working mode of the driven member 100.

When the driven member 100 is adjusted to the adjustment mode the first member 164, the sleeve 163 and the adjusting nut 108 are prevented from rotating about the axis Z-Z such that when the motor 20 is operated so as to cause the drive shaft 60A, the head portion 105 and the jaws 107 to rotate about the axis Z-Z the jaws 107 rotate relative to the adjusting nut 108. Rotation of the jaws 107 relative to the adjusting nut 108 causes the jaws 107 to move in an angular direction relative to the axis Z-Z either in a direction towards or away from the axis Z-Z so as to respectively either clamp or release the working element 120 from between the jaws 107. Alternatively, when the driven member 100 is adjusted to the working mode the first and second engagement portions 165, 168 of the first and second members 164, 167 are moved out of engagement by movement of the second member 167 away from the first member 164 along the direction of the axis Z-Z such that the first member 164, the sleeve 163 and the adjusting nut 108 are able to freely rotate about the axis Z-Z in unison with the head portion 105, the jaws 107 and the drive shaft 60A. Thus, in the working mode the working element 120 can remain gripped between the jaws 107 of the driven member 100 such that when the motor 20 is activated the driven member 100 and the working element 120 rotate to perform work on a workpiece.

Torque Control Mechanism

As mentioned above, the torque control mechanism 70 can be selectively engaged or disengaged. When the torque control mechanism 70 is engaged it is operable to control torque supplied by the motor 20 to the driven member 100 to render the driven member 100 stationary when the amount of torque supplied by the motor 20 to the driven member 100 exceeds a pre-determined level. When the torque control mechanism 70 is disengaged torque is supplied by the motor 20 to the driven member 100 directly regardless of the amount of torque.

Referring to FIGS. 2, 4, 6, 8 and 10 to 15, one form of the torque control mechanism 70 is illustrated which includes a biasing means in the form of a helical torque control spring 76 which is compressed between the clutch plate 74 and a threaded ring 80. The threaded ring 80 has a central aperture 81 that receives the drive shaft 60A therethrough. Accordingly, the threaded ring 80 is positioned between the clutch plate 74 and the driven member 100. An annular spring compression pad 89 is positioned within the central aperture 81 of the threaded ring 80. The spring compression pad 89 is configured to engage one end of the helical spring 76 while the other end of the helical spring 76 engages an annular spring engaging surface 77 of the clutch plate 74. Accordingly, the helical spring 76 is compressed between the spring compression pad 89 and the annular spring engaging surface 77 of the clutch plate 74. The spring compression pad 89 is configured to be rotatable relative to the threaded ring 80. The projections 79 of the sleeve portion 75 of the clutch plate 74 are configured to inter-engage with slots in the spring compression pad 89 so as to cause the spring compression pad 89 to rotate in unison with the clutch plate 74. Thus, the entire assembly of the clutch plate 74, the spring compression pad 89 and the helical torque control spring 76 rotate in unison about the axis Z-Z.

The threaded ring 80 includes an external helical thread 82 that threadably engages an internal helical thread 84 of an adjustment ring 86. The adjustment ring 86 is mounted to the body 16 of the drill 10 in such a way as to enable the adjustment ring 86 to be manually gripped and rotated about the axis Z-Z but not be movable in the direction of the axis Z-Z. In contrast, the threaded ring 80 is mounted within the adjustment ring 86 in such a way as to be movable in the direction of the axis Z-Z but to be unable to rotate about the axis Z-Z. Accordingly, rotation of the adjustment ring 86 in one direction causes the threaded ring 80 to move in one direction along the axis Z-Z whilst rotation of the adjustment ring 86 in the reverse direction causes the threaded ring 80 to move in the opposite direction along the axis Z-Z. Accordingly, rotation of the adjustment ring 86 causes the threaded ring 80 to increase or reduce the compression of the spring 76 between the spring compression pad 89 and the clutch plate 74. Changing the compression of the spring 76 changes the amount of force with which the second clutch surface 73 of the clutch plate 74 engages the first clutch surface 72 of the second output gear 65 along the direction of the axis Z-Z. As will be appreciated, changing the compression of the spring 76 changes the amount of torque that will be transmitted between the first clutch surface 72 of the second output gear 65 and the second clutch surface 73 of the clutch plate 74.

The first and second clutch surfaces 72, 73 of the torque control mechanism 70 are arranged with a series of radial grooves 72B, 73B and ridges 72A, 73A. The first clutch surface 72 includes successive and radially oriented ridges 72A and grooves 72B and the second clutch surface 73 includes similar successive and radially oriented ridges 73A and grooves 73B. The ridges 72A and grooves 72B of the first clutch surface 72 face towards and inter-engage with the grooves 73B and ridges 73A of the second clutch surface 73. Each of the ridges 72A, 73A and grooves 72B, 73B are respectively shaped with a pair of opposite sloping sides and a flat top or base extending between the sloping sides so as to have a generally trapezoidal profile or may be respectively convex or concave in shape.

When the torque controller 70 is engaged and the amount of torque supplied by the motor 20 through the transmission assembly 30 to the driven member 100 exceeds a pre-determined amount the ridges 72A, 73A begin to move over the grooves 72B, 73B and thereby force the clutch surfaces 72, 73 away from each other along the axis Z-Z with an amount of force sufficient to overcome the force of expansion of the spring 76 between the threaded ring 80 and the clutch plate 74. When the clutch surfaces 72, 73 are forced away from each other the second output gear 65 and the clutch plate 74 can rotate relative to each other thereby rendering the driven member 100 stationary or at least rotating at a lesser speed of rotation than that of the second assembly 60. When this occurs, the clutch plate 74 oscillates back and forth in the direction of the axis Z-Z relative to the output gear 65 as the ridges 72A, 73A continue to move over the grooves 72B, 73B.

When the torque controller 70 is engaged and the amount of torque supplied by the motor 20 through the transmission assembly 30 to the driven member 100 is less than the pre-determined amount the ridges 72A, 73A and grooves 72B, 73B remain interlocked and the second assembly 60 rotates in unison with the clutch plate 74 such that the driven member 100 is rotated about the axis Z-Z at the same speed of rotation as that of the second assembly 60 driven by the motor 20. Accordingly, the torque control mechanism 70 is operable to render the driven member stationary 100 when the amount of torque supplied by the motor 20 to the driven member 100 exceeds a pre-determined level.

The pre-determined level of torque at which the torque control mechanism 70 is operable to render the driven member stationary 100 when the amount of torque supplied by the motor 20 to the driven member 100 exceeds a pre-determined level can be adjusted by adjusting the force of expansion exerted by the spring 76 between the threaded ring 80 and the clutch plate 74 by rotating the adjustment ring 86 about the axis Z-Z and thereby adjusting the extent to which the by the spring 76 is compressed between the threaded ring 80 and the clutch plate 74.

The means by which the torque control mechanism 70 can be engaged and disengaged will now be described. The longitudinal groove 63 in the drive shaft 60A extends in the direction of the axis Y-Y from the first end 61 along a portion of the length of the drive shaft 60A towards the second end 62. The key member 67, which includes a longitudinal bar portion 67A, is positioned within the groove 63 such that the bar portion 67A extends in the direction of the axis Y-Y. The key member 67 also includes a transverse locking tab 67B at one end of the bar portion 67A and a transverse actuating tab 67C at the other end of the bar portion 67A. The key member 67 is configured to slide fore and aft in the groove 63 along the direction of the axis Y-Y between a rearward position and a forward position.

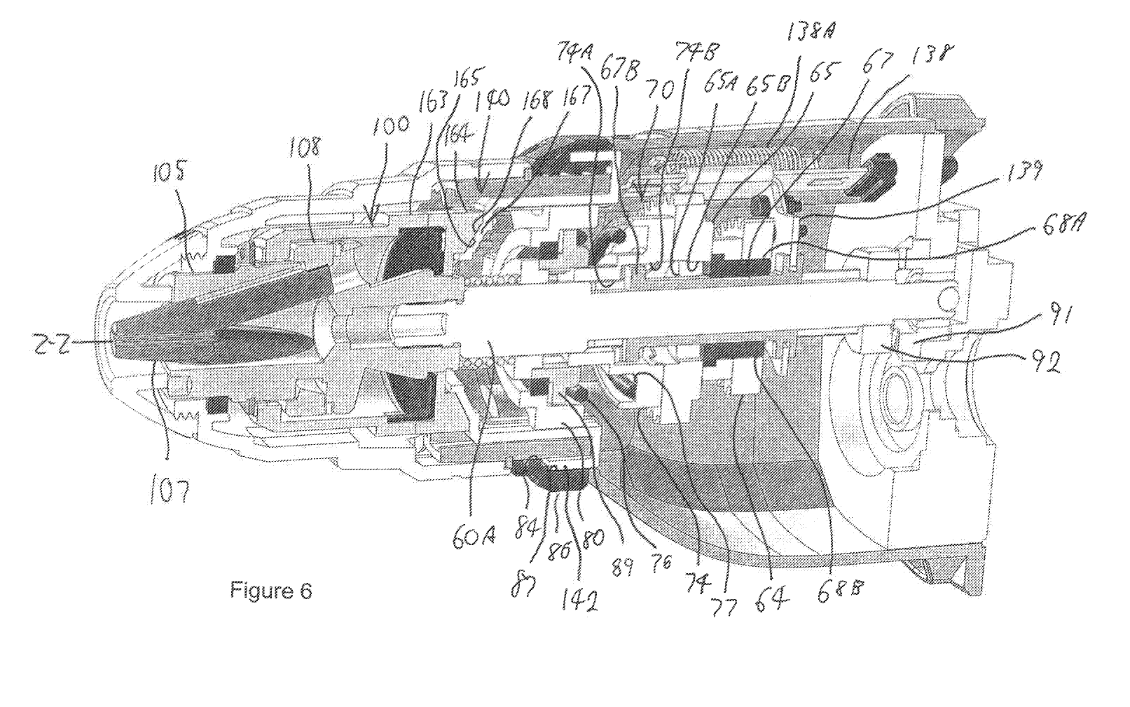

As can be seen in FIGS. 6, 8 and 10, the central aperture 65A of the second output gear 65 includes a slot 65B which receives the locking tab 67B when the key member 67 is in the rearward position to thereby lock the second output gear 65 to the drive shaft 60A. Thus, if the key member 67 is in the rearward position the second output gear 65 and the drive shaft 60 are locked together and rotate in unison and not relative to each other. As will be appreciated, when the key member 67 is in the rearward position the clutch mechanism 70 is disengaged.

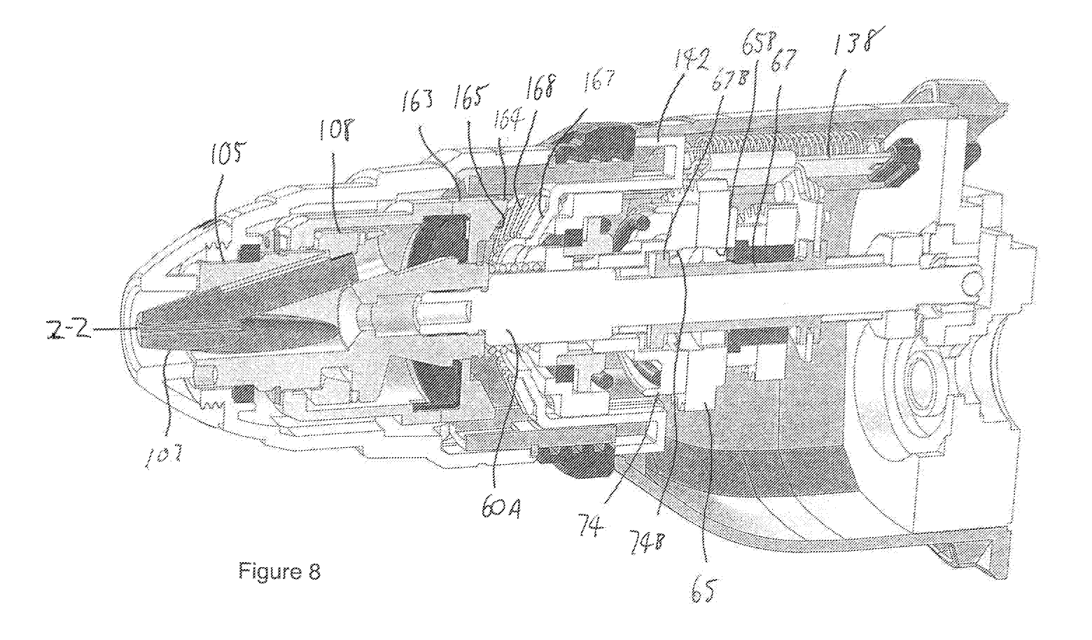

Conversely, when the key member 67 is in the forward position to thereby unlock the second output gear 65 from the drive shaft 60A the second output gear 65 and the drive shaft 60 are able to freely rotate relative to each other. As will be appreciated from the description below, when the key member 67 is in the forward position the clutch mechanism 70 is engaged. As can be seen in FIGS. 6 and 8, the central aperture 74A of the clutch plate 74 includes an opening in the form of a slot 74B which receives the locking tab 67B when the key member 67 is in the forward position to thereby lock the clutch plate 74 to the drive shaft 60A. Thus, if the key member 67 is in the forward position and if the amount of torque supplied by the motor 20 through the transmission assembly 30 to the driven member 100 is less than the pre-determined amount the clutch plate 74 and the drive shaft 60A rotate in unison with the first and second output gears 64, 65. If the key member 67 is in the forward position and if the amount of torque supplied by the motor 20 through the transmission assembly 30 to the driven member 100 is greater than the pre-determined amount the second output gear 65 rotates relative to the clutch plate 74 and the drive shaft 60A to render the driven member 100 stationary. Accordingly, when the key member 67 is in the forward position the clutch mechanism 70 is engaged.

The clutch mechanism 70 is only engageable when the gear assembly 30 is in the first speed, or low speed, setting of the gear assembly 30 which is when the motor 20 drives rotation of the second output gear 65 via the second input gear 53. However, the clutch mechanism can either be engaged or disengaged when the gear assembly 30 is in the first speed, or low speed, setting.

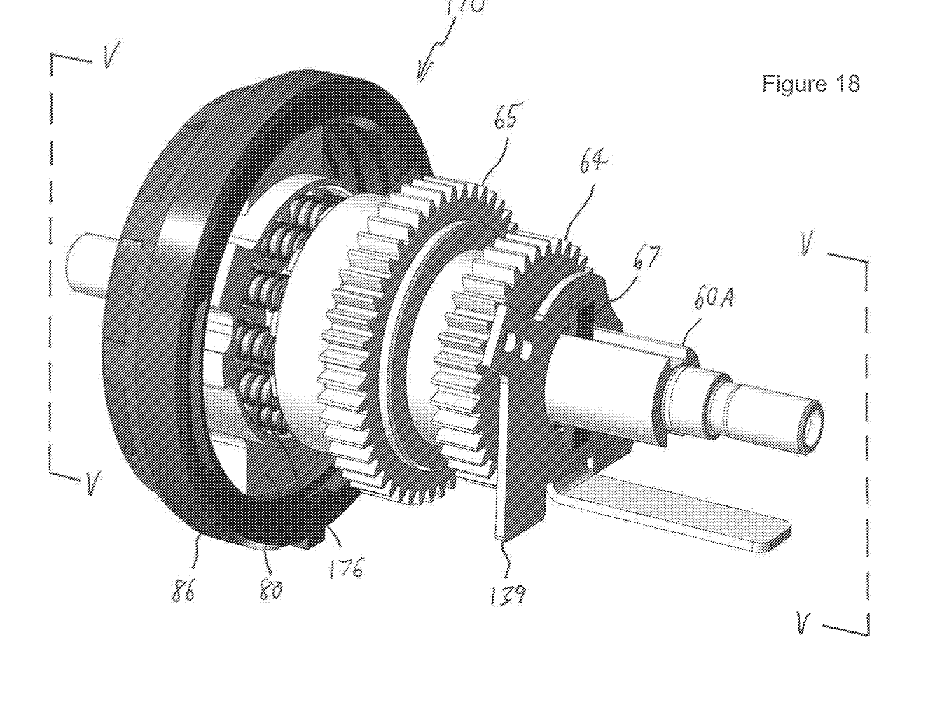

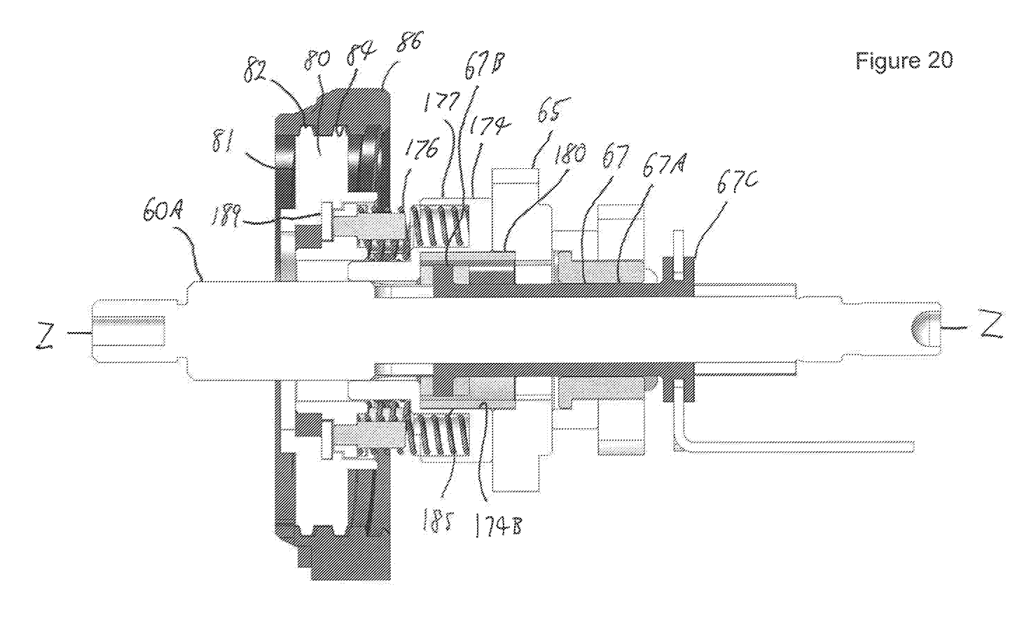

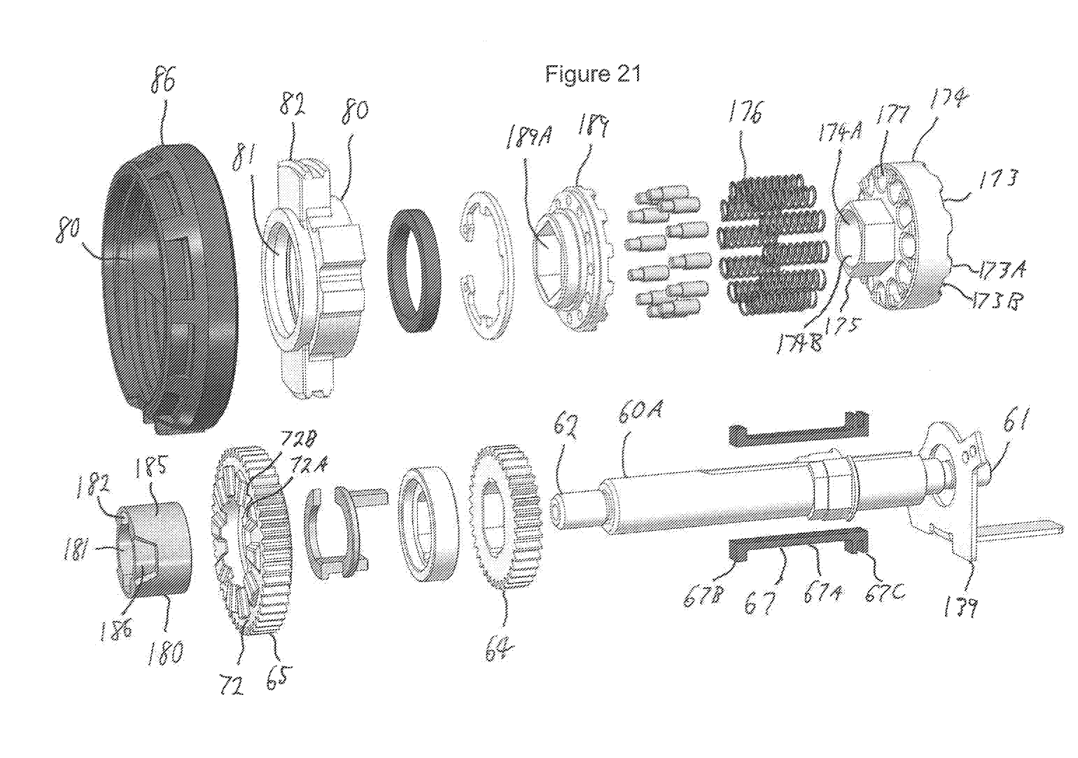

Referring to FIGS. 18 to 22, another form of the torque control mechanism 170 is illustrated which achieves substantially the same function as the embodiment of the torque control mechanism 70 of FIGS. 2, 4, 6, 8 and 10 to 15. That is, to control torque supplied by the motor 20 to the driven member 100 to render the driven member 100 stationary when the amount of torque supplied by the motor 20 to the driven member 100 exceeds a pre-determined level. In the embodiments of the torque control mechanism 70, 170 of FIGS. 2, 4, 6, 8 and 10 to 15 and of FIGS. 18 to 22 like reference numerals are used for like components.

The torque control mechanism 170 of FIGS. 18 to 22 includes another form of clutch plate 174 positioned concentrically around the drive shaft 60A of the second assembly 60 immediately adjacent the second output gear 65. The clutch plate 174 includes a central aperture 174A for receiving the drive shaft 60A therethrough. The forward facing first annular clutch surface 72 of the second output gear 65 and a rearward facing second annular clutch surface 173 of the clutch plate 174 cooperate to provide the torque control function of the torque control mechanism 170 in a manner which will be described in more detail below. The clutch plate 174 also includes an integrally attached sleeve portion 175 which is arranged concentrically around the drive shaft 60A with a nut shaped outer surface.

The torque control mechanism 170 also includes a biasing means in the form of a plurality of helical torque control springs 176 which are compressed between the clutch plate 174 and a threaded ring 80. The threaded ring 80 has a central aperture 81 that receives the drive shaft 60A therethrough. Accordingly, the threaded ring 80 is positioned between the clutch plate 174 and the driven member 100. An annular spring compression member 189 is positioned within the central aperture 81 of the threaded ring 80. The spring compression member 189 is configured to engage one end of each of the helical springs 176 while the other end of each of the helical springs 176 fits within and engages a respective spring receiving aperture 177 provided within a surface of the clutch plate 174 opposite to the rearward facing second annular clutch surface 173. Accordingly, the helical springs 176 are compressed between the spring compression member 189 and the spring receiving aperture 177 of the clutch plate 174. The spring compression member 189 is configured to be rotatable relative to the threaded ring 80. The nut shaped outer surface of the sleeve portion 175 of the clutch plate 174 fits within a complimentary shaped opening 189A through the spring compression member 189 so as to cause the spring compression member 189 to rotate in unison with the clutch plate 174. Thus, the entire assembly of the clutch plate 174, the spring compression member 189 and the helical torque control springs 176 rotate in unison about the axis Z-Z.

In the embodiment of FIGS. 18 to 22 the external helical thread 82 of the threaded ring 80 threadably engages the internal helical thread 84 of the adjustment ring 86 in a manner identical to the embodiment of the torque control mechanism 70 of FIGS. 2, 4, 6, 8 and 10 to 15. The adjustment ring 86 is mounted to the body 16 of the drill 10 to enable manual rotation of the adjustment ring 86 about the axis Z-Z but not be movable in the direction of the axis Z-Z whereas the threaded ring 80 is mounted within the adjustment ring 86 in such a way as to be movable in the direction of the axis Z-Z but to be unable to rotate about the axis Z-Z. Accordingly, rotation of the adjustment ring 86 in one direction causes the threaded ring 80 to move in one direction along the axis Z-Z whilst rotation of the adjustment ring 86 in the reverse direction causes the threaded ring 80 to move in the opposite direction along the axis Z-Z. Accordingly, rotation of the adjustment ring 86 causes the threaded ring 80 to increase or reduce the compression of the springs 176 between the spring compression member 189 and the clutch plate 174. Changing the compression of the springs 176 changes the amount of force with which the second clutch surface 173 of the clutch plate 174 engages the first clutch surface 72 of the second output gear 65 along the direction of the axis Z-Z. As will be appreciated, changing the compression of the springs 176 changes the amount of torque that will be transmitted between the first clutch surface 72 of the second output gear 65 and the second clutch surface 173 of the clutch plate 174.

Like the embodiment of the torque control mechanism 70 of FIGS. 2, 4, 6, 8 and 10 to 15, in the embodiment of the torque control mechanism 170 of FIGS. 18 to 22 the first and second clutch surfaces 72, 173 of the torque control mechanism 170 are arranged with a series of radial grooves 72B, 173B and ridges 72A, 173A. The first clutch surface 72 includes successive and radially oriented ridges 72A and grooves 72B and the second clutch surface 173 includes similar successive and radially oriented ridges 173A and grooves 173B. The ridges 72A and grooves 72B of the first clutch surface 72 face towards and inter-engage with the grooves 173B and ridges 173A of the second clutch surface 173. Each of the ridges 72A, 173A and grooves 72B, 173B are respectively shaped with a pair of opposite sloping sides and a flat top or base extending between the sloping sides so as to have a generally trapezoidal profile or may be respectively either convex or concave in shape.

When the torque control mechanism 170 is engaged and the amount of torque supplied by the motor 20 through the second output gear 65 of the transmission assembly 30 to the driven member 100 exceeds a pre-determined amount the ridges 72A, 173A begin to move over the grooves 72B, 173B and thereby force the clutch surfaces 72, 173 away from each other along the axis Z-Z. When the amount of torque exceeds the pre-determined amount the clutch surfaces 72, 173 move away from each other with an amount of force sufficient to overcome the force of expansion of the springs 176 between the threaded ring 80 and the clutch plate 174. When the clutch surfaces 72, 173 are forced away from each other the second output gear 65 and the clutch plate 174 can rotate relative to each other thereby rendering the driven member 100 stationary or at least rotating at a lesser speed of rotation than that of the second assembly 60. When this occurs, the clutch plate 174 oscillates back and forth in the direction of the axis Z-Z relative to the output gear 65 as the ridges 72A, 173A continue to move over the grooves 72B, 173B.

When the torque control mechanism 170 is engaged and the amount of torque supplied by the motor 20 through the transmission assembly 30 to the driven member 100 is less than the pre-determined amount the ridges 72A, 173A and grooves 72B, 173B remain interlocked and the second assembly 60 rotates in unison with the clutch plate 174 such that the driven member 100 is rotated about the axis Z-Z at the same speed of rotation as that of the second assembly 60 driven by the motor 20. Accordingly, the torque control mechanism 170 is operable to render the driven member stationary 100 when the amount of torque supplied by the motor 20 to the driven member 100 exceeds a pre-determined level.

The pre-determined level of torque at which the torque control mechanism 170 is operable to render the driven member stationary 100 when the amount of torque supplied by the motor 20 to the driven member 100 exceeds a pre-determined level can be adjusted. This is achieved by rotating the adjustment ring 86 about the axis Z-Z and thereby adjusting the extent to which the springs 176 are compressed between the threaded ring 80 and the clutch plate 174. Adjusting the extent to which the springs 176 are compressed between the threaded ring 80 and the clutch plate 174 adjusts the force exerted by the springs 176 between the threaded ring 80 and the clutch plate 174 to thereby adjust the pre-determined level of torque at which the torque control mechanism 170 is operable to render the driven member stationary 100 when the amount of torque supplied by the motor 20 to the driven member 100 exceeds a pre-determined level.

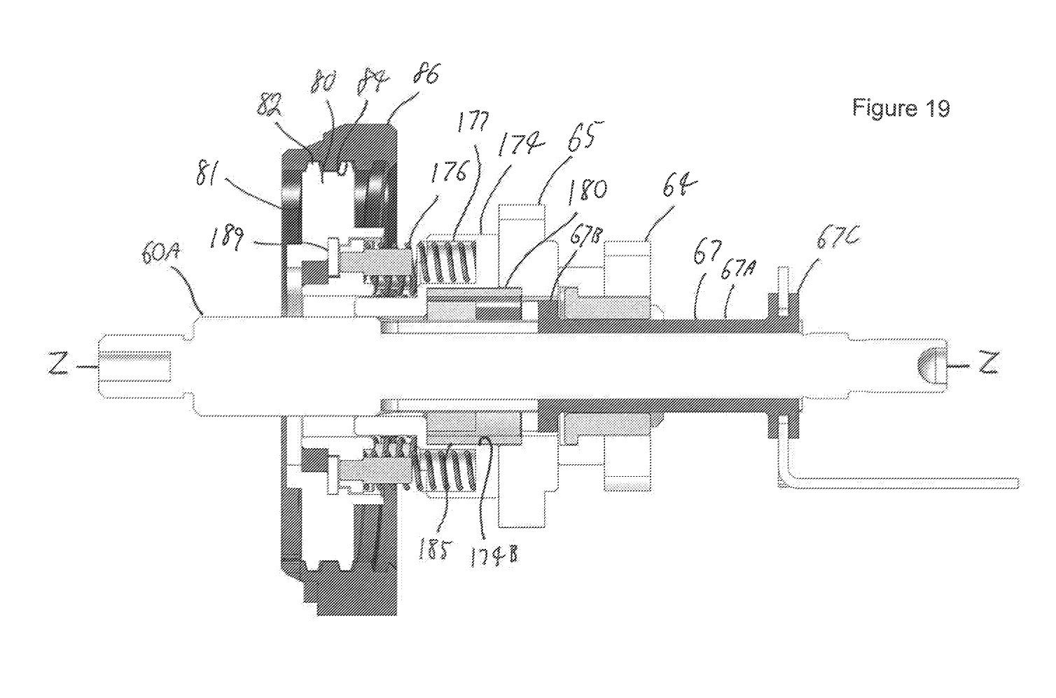

The means by which the torque control mechanism 170 of the embodiment of FIGS. 18 to 22 is engaged or disengaged is the same as the means by which the torque control mechanism 70 of the embodiment of FIGS. 2, 4, 6, 8 and 10 to 15 is engaged or disengaged. FIG. 19 illustrates a side view of a cross section of the torque control mechanism 170 wherein the slot 65 B within the central aperture 65A of the second output gear 65 receives the locking tab 67B of the key member 67 which is in the rearward position to thereby lock the second output gear 65 to the drive shaft 60A. Thus, the clutch mechanism 170 is disengaged. Conversely, when the key member 67 is in the forward position to thereby unlock the second output gear 65 from the drive shaft 60A the second output gear 65 and the drive shaft 60 are able to freely rotate relative to each other. As will be appreciated from the description below, when the key member 67 is in the forward position the clutch mechanism 70 is engaged. As can be seen in FIGS. 6 and 8, the central aperture 74A of the clutch plate 74 includes an opening in the form of a slot 74B which receives the locking tab 67B when the key member 67 is in the forward position to thereby lock the clutch plate 74 to the drive shaft 60A. Thus, if the key member 67 is in the forward position and if the amount of torque supplied by the motor 20 through the transmission assembly 30 to the driven member 100 is less than the pre-determined amount the clutch plate 74 and the drive shaft 60A rotate in unison with the first and second output gears 64, 65. If the key member 67 is in the forward position and if the amount of torque supplied by the motor 20 through the transmission assembly 30 to the driven member 100 is greater than the pre-determined amount the second output gear 65 rotates relative to the clutch plate 74 and the drive shaft 60A to render the driven member 100 stationary. Accordingly, when the key member 67 is in the forward position the clutch mechanism 70 is engaged.

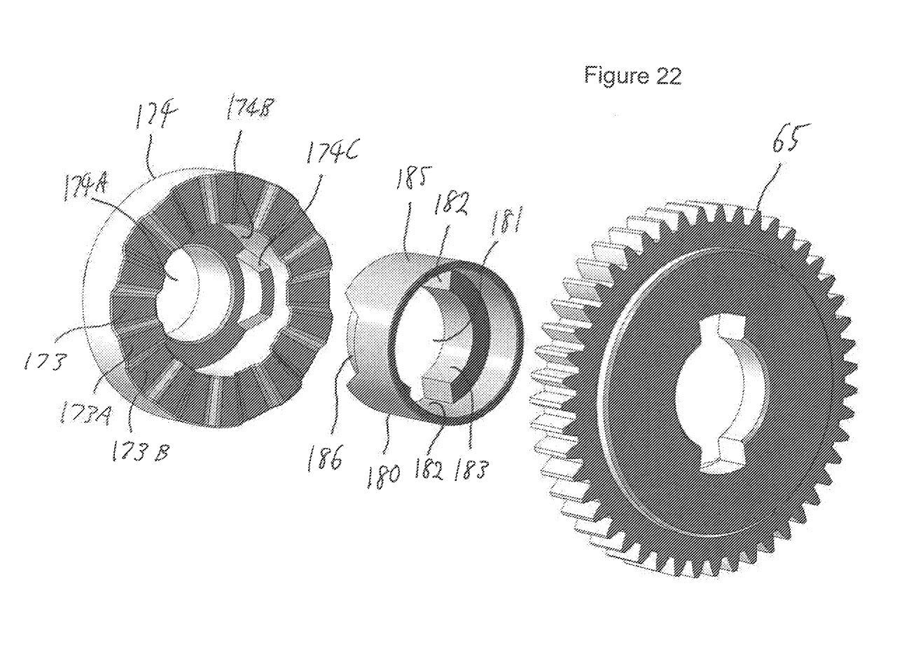

In the embodiment of the torque control mechanism 170 of FIGS. 18 to 22, as can be seen best in FIG. 22, the central aperture 174A of the clutch plate 174 includes an annular radially inwardly facing ring shaped surface 174B including a pair of inwardly extending projections 174C extending radially inwardly into the central aperture 174A. Each of the projections 174C is trapezoidal in shape and tapers in the rearward direction along the axis Y-Y. The torque control mechanism 170 further includes a member located intermediate the drive shaft 60A and the clutch plate 174 in the form of a clutch selector 180. The clutch selector 180 is a generally ring shaped member including a central aperture 181 for receiving the drive shaft 60A therethrough. A wall 183 defining the central aperture 181 of the clutch selector 180 includes a pair of opposing inner slots 182 either of which, when the key member 67 is in the forward position for engaging the clutch mechanism 170, receives the locking tab 67B to thereby lock the clutch selector 180 to the drive shaft 60A. The clutch selector 180 also includes a radially outward facing surface 185, which when the clutch selector 180 is positioned within the central aperture 174A of the clutch plate 174, face the radially inwardly facing surface 174B of the clutch plate 174. The radially outward facing surface 185 of the clutch selector 180 includes a pair of outer slots 186. Each of the outer slots 186 is trapezoidal in shape and tapers in the forward direction along the axis Y-Y. When the clutch selector 180 is positioned within the central aperture 174A of the clutch plate 174 each of the outer slots 186 of the clutch selector 180 receives a respective one of the inwardly extending projections 174C of the clutch plate 174. As will be appreciated, the arrangement of the outer slots 186 and the inwardly extending projections may be reversed such that the clutch selector 180 may include outwardly extending projections which are cooperable with slots within the inwardly facing surface 174B of the clutch plate 174. Other arrangements than the slot and projection configuration disclosed herein may be adopted to achieve the function described herein.

In use, when the key members 67 are in the forward position for engaging the clutch mechanism 170 the inner slots 182 of the clutch selector 180 receive the locking tabs 67B to thereby rotatably lock the clutch selector 180 to the drive shaft 60A. The inwardly extending projections 174C of the clutch plate 174 remain within the outer slots 186 of the clutch selector 180 such that the outer slots 186 and the inwardly extending projections 174C abut each other in the direction of rotation about the axis Z-Z. The abutment between the outer slots 186 and the inwardly extending projections 174C is such that the clutch plate 174 and the clutch selector 180 are substantially rotatably fixed together about the axis Z-Z. Accordingly, the clutch plate 174 is substantially rotatably locked to the drive shaft 60A by the clutch selector 180 when the key members 67 are in the forward position.

When the amount of torque supplied from the motor 20 through the transmission assembly 30 to the second output gear 65 exceeds a predetermined amount the ridges 72A and grooves 72B of the second output gear 65 begin to move over the ridges 173A and grooves 173B of the clutch plate 174. As a result, the clutch surfaces 72, 173 are forced away from each other along the axis Z-Z with an amount of force sufficient to overcome the force exerted by the springs 176 between the threaded ring 80 and the clutch plate 174. Thus, the second output gear 65 and the clutch plate 174 begin to rotate relative to each other about the axis Z-Z. In particular, when the amount of torque supplied from the motor 20 through the transmission assembly 30 to the second output gear 65 exceeds a predetermined amount the clutch plate 174, the clutch selector 180 and the drive shaft 60A remain substantially stationary whereas the second output gear 65 rotates about the axis Z-Z.

The tapering of the outer slots 186 in the forward direction and the tapering of the inwardly extending projections 174C in the rearward direction along the axis Y-Y enables the outer slots 186 and the inwardly extending projections 174C to remain in abutment with each other and substantially rotatably fixed together about the axis Z-Z despite relative movement of the clutch plate 174 and the clutch selector 180 along the axis Z-Z. A small amount of relative rotation of the clutch plate 174 and the clutch selector 180 can occur but remain substantially rotatably fixed together. Thus, the clutch plate 174 and the clutch selector 180 remain rotatably fixed together when the clutch mechanism 170 is engaged such that rotation of the clutch plate 174 about the axis Z-Z when the amount of torque supplied from the motor 20 through the transmission assembly 30 to the second output gear 65 is less than a predetermined amount is transferred to the drive shaft 60A via the clutch selector 180.

The clutch selector 180 is arranged so as not to move in the direction of the axis Z-Z. Thus, in the embodiment of the torque control mechanism 170 of FIGS. 18 to 22, when the key members 67 are in the forward position for engaging the clutch mechanism 170, the locking tab 67B of each of the key members 67 is positioned within one of the inner slots 182 of the clutch selector 180 and the clutch selector 180 does not move in the direction of the axis Z-Z relative to the key members 67. Instead, the clutch plate 174 and the clutch selector 180 move relative to each other in the direction of the axis Z-Z. Accordingly, there is reduced friction between the locking tab 67B of each of the key members 67 and the clutch selector 180 due to relative movement therebetween because the amount of relative movement therebetween is reduced. Thus, premature wearing of the locking tab 67B is reduced. Instead, the bulk of any friction which occurs as a result of operation of the torque control mechanism 170 due to movement of the clutch plate 174 in the direction of the axis Z-Z occurs between the inwardly extending projections 174C of the clutch plate 174 and the outer slots 186 of the clutch selector 180 and to a lesser extent between the radially outward facing surface 185 of the clutch selector 180 and the radially inwardly facing surface 174B of the clutch plate 174. As a result, the longevity of the torque control mechanism 170 is enhanced.

Switch

Referring to FIGS. 1, 2, 5, 7, 9, 16 and 17 the power tool 10 further includes a switch mechanism 130. The switch mechanism 130 is configured to actuate the transmission assembly 30 between the first and second speed settings. The switch mechanism 130 is also configured to adjust the driven member 100 between the working mode and the adjustment mode. The switch mechanism 130 is also configured to adjust the torque control mechanism 70 between the engaged and disengaged modes.

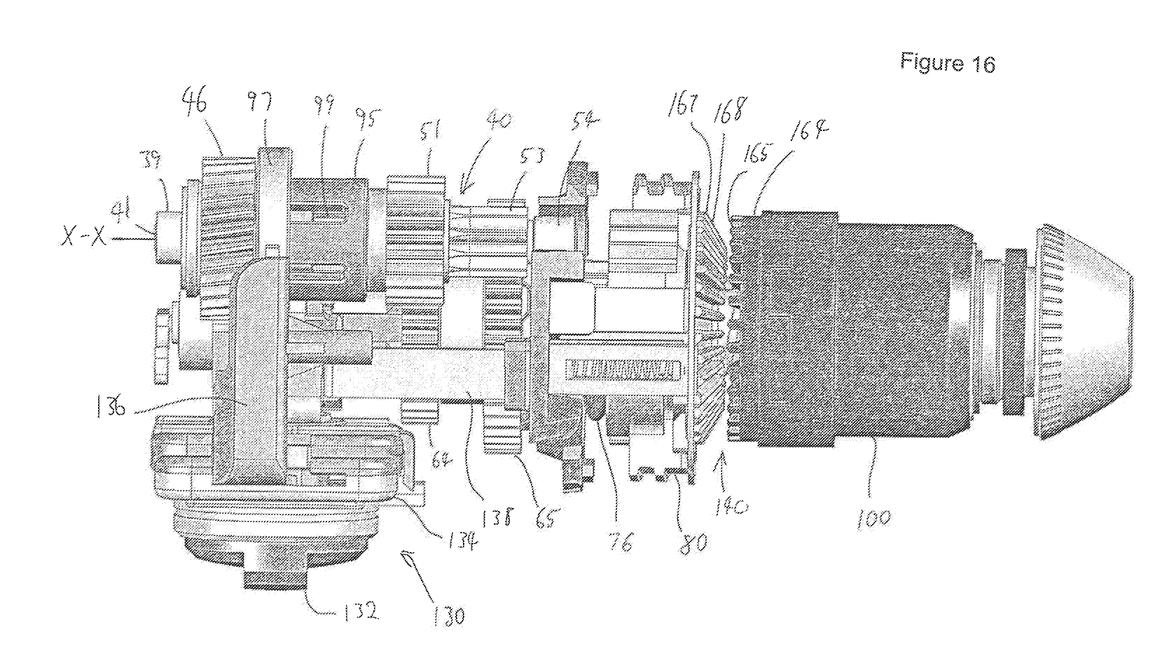

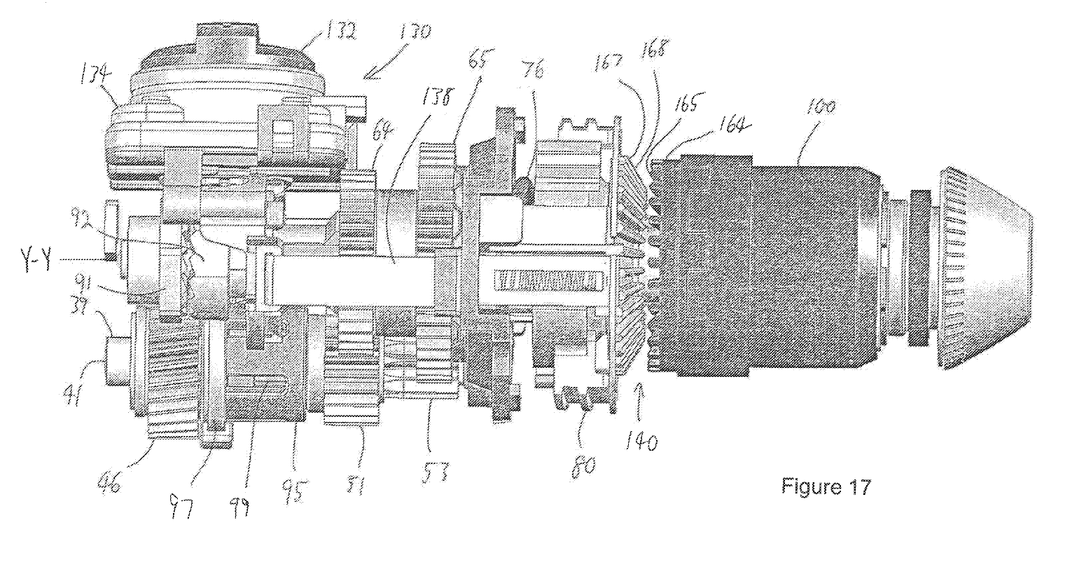

The switch mechanism 130 includes a manual selector in the form of a selection dial 132 which is mounted to a switch housing 134. As illustrated in FIGS. 1 and 2, the selection dial 132 is mounted on a side of the body 16 of the housing 12 of the power tool 10 so as to be accessible by a user. In the embodiments illustrated in the Figures, the manual selector is in the form of the rotary selection dial 132. However, it is to be appreciated that any suitable form of manual selection device could substitute for the rotary selection dial 132. For example, a manual selector which moves in a linear direction could substitute for the rotary selection dial 132. Alternatively, a powered actuator could be substituted for the rotary selection dial 132. The person skilled in the art would appreciate that a variety of different forms of manual selector or selection means could be substituted for the rotary selection dial 132 and achieve the same function and that such selectors and means would fall within the scope of the disclosure herein. As shown in FIGS. 16 and 17, the selection dial 132 is coupled to a gear selection actuator 136 and a driven member mode selection actuator 138.

As shown in FIG. 16, the gear selection actuator 136 extends between the switch housing 134 and the gear selection ring 97. The gear selection actuator 136 is coupled to the gear selection ring 97. The switch mechanism 130 is configured so that rotation of the selection dial 132 causes the gear selection actuator 136 to move the gear selection ring 97 in the direction of the axis X-X of the first assembly 40 between a first position wherein, as shown in FIGS. 11 to 14, the gear selection ring 97 and the legs 98 thereof are positioned within the grooves 44 of the first castellated sleeve 43, and a second position, as shown in FIG. 15, wherein the legs 98 of the gear selection ring 97 are positioned within the grooves 55 of the second castellated sleeve 50. Accordingly, the gear selection actuator 136 is configured to adjust the gear selection ring 97 between the first and second positions which respectively correspond to the first speed, or low speed, setting and the second speed, or high speed, setting of the transmission assembly 30.

As shown in FIGS. 16 and 17, the driven member mode selection actuator 138 is coupled to the selection dial 132 of the switch mechanism 130 so as to be movable in the direction of the axis Y-Y of the second assembly 60 of the transmission assembly 30. The driven member mode selection actuator 138 is also coupled to the second member 167 of the driven member 100. The switch mechanism 130 is configured so that rotation of the selection dial 132 causes the driven member mode selection actuator 138 to move in the direction of the axis Y-Y of the second assembly 60 between a first position and a second position. In the first position the second member 167, and the second engagement portion 168 of the second member 167, is immediately adjacent to and in meshing engagement with the first engagement portion 165 of the first member 164. In the second position the second engagement portion 168 of the second member 167 is spaced apart from and not in meshing engagement with the first engagement portion 165. The first position of the driven member mode selection actuator 138 in which the second engagement portion 168 of the second member 167 is immediately adjacent to and in meshing engagement with the first engagement portion 165 of the first member 164 corresponds to the adjustment mode of the driven member 100. The second position of the driven member mode selection actuator 138 in which the second engagement portion 168 of the second member 167 is spaced apart from and not in meshing engagement with the first engagement portion 165 of the first member 164 corresponds to the drive mode of the driven member 100.

As illustrated in FIGS. 6, 8 and 10 the driven member mode selection actuator 138 is also coupled to a torque control mechanism selection actuator 139. The torque control mechanism selection actuator 139 is coupled to the transverse actuating tab 67C of the key member 67. Accordingly, when the selection dial 132 of the switch mechanism 130 is operated to move the driven member mode selection actuator 138 it also moves the torque control mechanism selection actuator 139 in the direction of the axis Y-Y. Movement of the torque control mechanism selection actuator 139 in the direction of the axis Y-Y causes the key member 67 to slide fore and aft in the groove 63 along the direction of the axis Y-Y between the rearward and forward positions as described above. Accordingly, the switch mechanism 130 is configured so that rotation of the selection dial 132 causes the torque control mode selection actuator 139 and the key member 67 to move in the direction of the axis Y-Y between the rearward position in which the clutch mechanism 70 is disengaged and the forward position in which the clutch mechanism 70 is engaged.

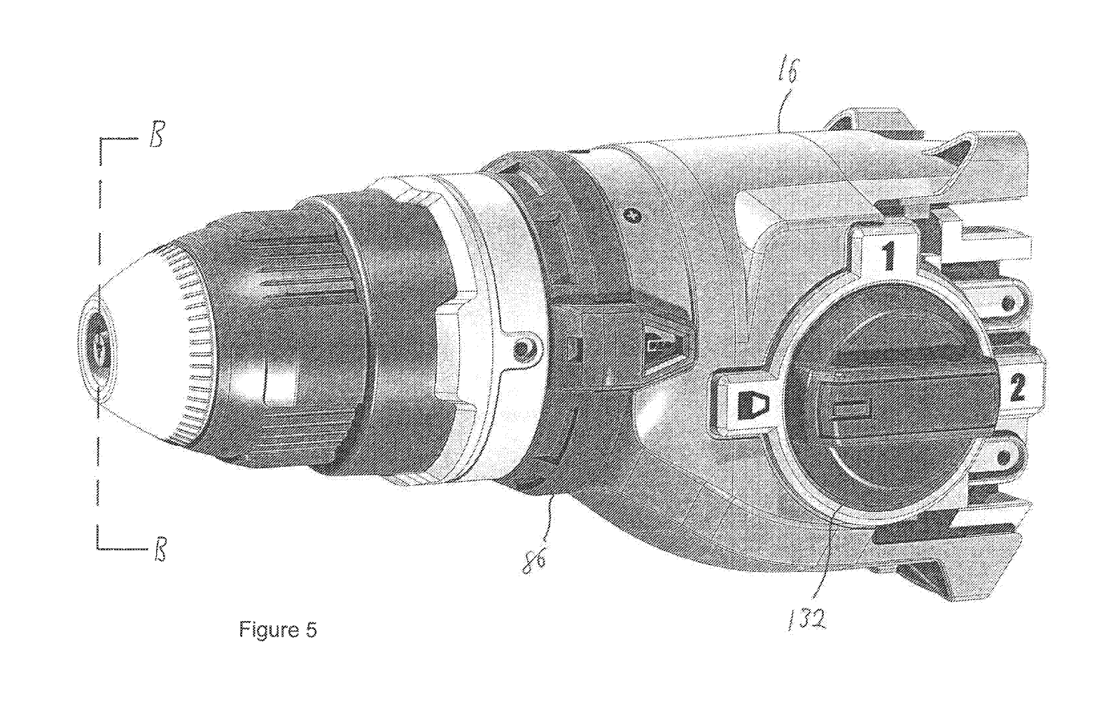

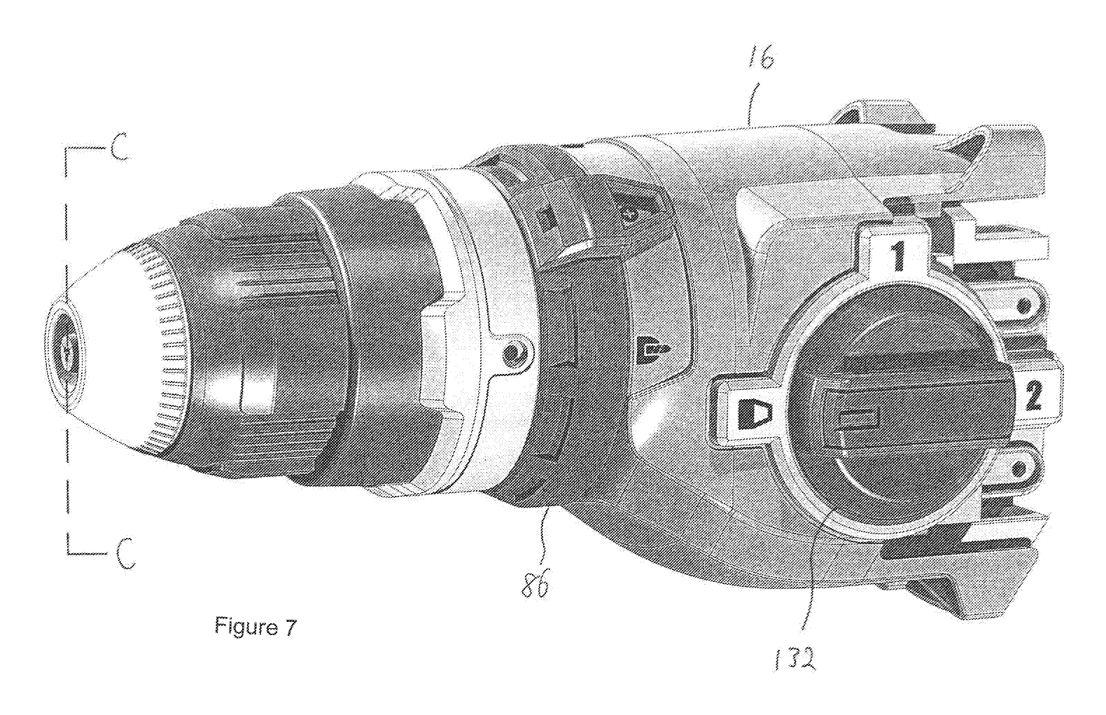

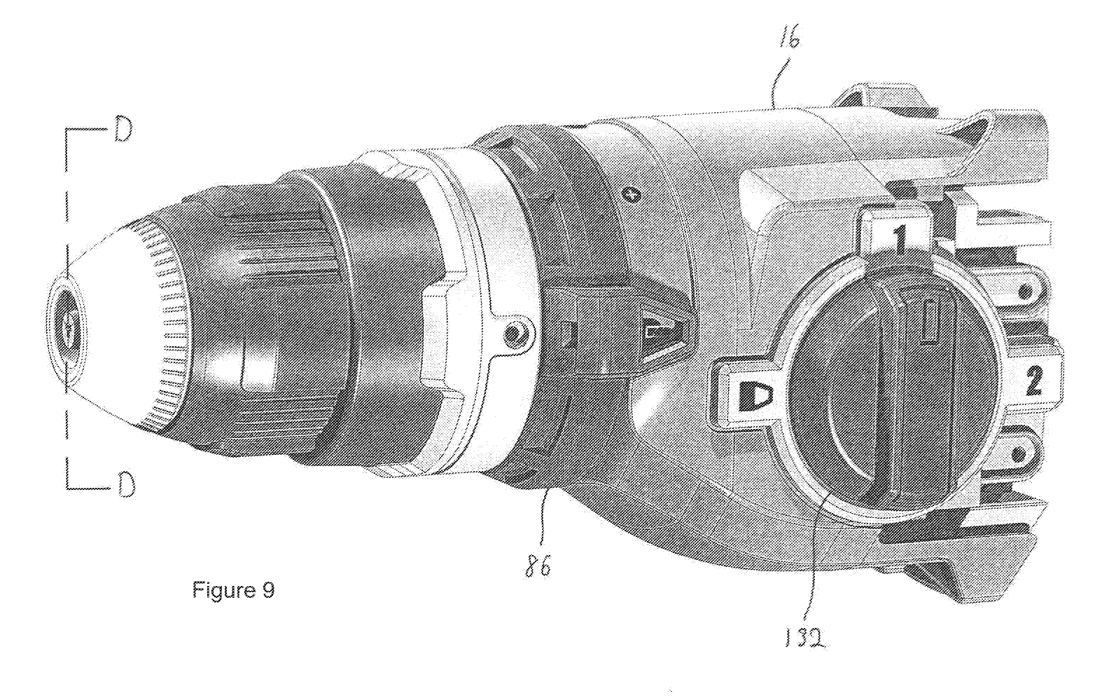

The switch mechanism 130 is configured such that the selection dial 132 includes three distinct positions, represented by an icon and the numerals 1 and 2 on the selection dial 132 in FIGS. 7 and 9. Moving the selection dial 132 to a first one of the positions represented by an icon on the selection dial 132 in FIGS. 7 and 9, causes, as illustrated in FIGS. 5 to 8, the gear selection actuator 136 to actuate the gear selection ring 97 to the first position which corresponds to the first speed, or low speed, setting of the transmission assembly 30. Moving the selection dial 132 to the first one of the settings also causes the torque control mode selection actuator 139 to move the key member 67 to the forward position in which the clutch mechanism 70 is engaged. Moving the selection dial 132 to the first one of the settings also causes, subject to the position of the adjustment ring 86, the driven member mode selection actuator 138 to be biased, by means of a biasing spring 138A, towards the first position in which the second engagement portion 168 of the second member 167 is in meshing engagement with the first engagement portion 165 of the first member 164. Thus, moving the selection dial 132 to the first one of the settings contributes to selecting the adjustment mode of the driven member 100.

The torque control mode selection actuator 139 and the driven member mode selection actuator 138 are coupled together. The driven member mode selection actuator 138 is coupled via the biasing spring 138A to the second member 167. When the selection dial 132 is moved to the first one of the positions the torque control mode selection actuator 139 and the driven member mode selection actuator 138 moves in the direction of the axis Z-Z towards the first member 164 which in turn causes the biasing spring 138A to bias the second member 167 towards the first member 164. A tab portion 142 is coupled to and moves with the second member 167.

As shown in FIG. 6, the adjustment ring 86 includes a slot 87 which extends in the direction of the axis Z-Z. The adjustment ring 86 can be manually rotated about the axis Z-Z between a position in which the slot 87 is aligned with and can receive the tab portion 142 of the second member 167 and a position in which the slot 87 is not aligned with and cannot receive the tab portion 142 of the second member 167. When the adjustment ring 86 is manually rotated about the axis Z-Z to an appropriate setting and when the selection dial 132 is moved to the first one of the positions, as in FIGS. 5 and 6, the slot 87 is positioned to receive, and does receive, the tab portion 142 of the second member 167 so that the second member 167 is in the first position in engagement with the first member 164 to thereby select the adjustment mode of the driven member 100.

When the selection dial 132 is in the first one of the positions and the adjustment ring 86 is manually rotated about the axis Z-Z to an appropriate setting the second member 167 and the tab portion 142 are respectively biased into engagement with the first member 164 and biased into the slot 87. Thus, when the adjustment ring 86 is manually rotated about the axis Z-Z out of the setting in which the tab portion 142 is receivable within the slot 87, as in FIGS. 7 and 8, this either forces the tab portion 142 to move out of the slot 87 when the selection dial 132 is already in the first one of the positions or prevents the tab portion 87 from entering the slot 87 when the selection dial 132 is moved into the first one of the positions. As such when the adjustment ring 86 is manually rotated about the axis Z-Z out of the setting in which the tab portion 142 is receivable within the slot 87 the second member 167 is either moved to the second position or is maintained in the second position out of engagement with the first member 162 to thereby select the working mode of the driven member 100.

As can be appreciated, the biasing spring 138A continues to bias the second member 167 and the tab portion 142 so that when the adjustment ring 86 is rotated to align with the tab portion 142 the tab portion 142 is biased into and is received by the slot 87. Thus, when the selection dial 132 is in the first position the adjustment ring 86 is capable of engaging and disengaging the adjustment mode of the driven member 100 because when the selection dial 132 is in the first position the biasing spring 187A biases the tab portion 142 into the slot 87 if and when the adjustment ring 86 is rotated to align with and receive the tab portion 142.

Accordingly, when the selection dial 132 is moved to the first one of the positions the adjustment ring 86 can be manually rotated about the axis Z-Z between a position in which the driven member 100 is in the drive mode and a position in which the driven member 100 is in the adjustment mode. Thus, manual rotation of the adjustment ring 86 about the axis Z-Z out of the setting in which the tab portion 142 is receivable within the slot 87 facilitates selection of the drive mode of the driven member 100 and of the power tool 10 when the selection dial 132 is in the first one of the settings illustrated in FIGS. 5 to 8.

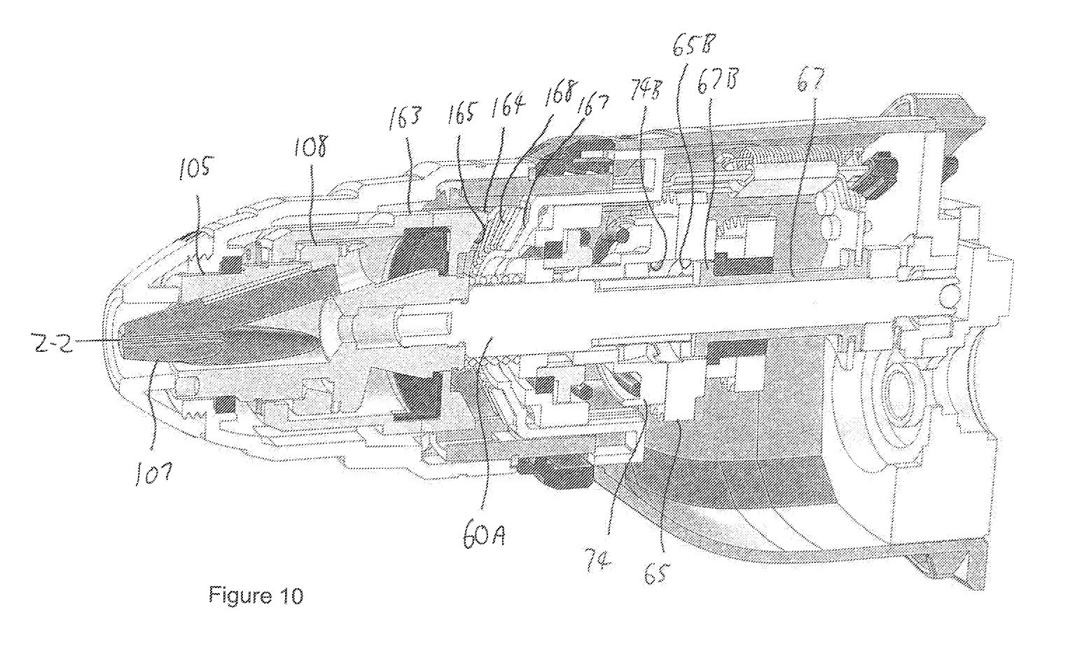

Moving the selection dial 132 to a second one of the positions, represented by the numeral 1 on the selection dial 132 in FIGS. 7 and 9, causes, as illustrated in FIG. 10, the gear selection actuator 136 to actuate the gear selection ring 97 to the first position which corresponds to the first speed, or low speed, setting of the transmission assembly 30. Moving the selection dial 132 to the second one of the positions also causes the driven member mode selection actuator 138 to actuate the second member 167 to the second position which corresponds to the drive mode of the driven member 100. Moving the selection dial 132 to the second one of the positions also causes the torque control mode selection actuator 139 to move the key member 67 to the rearward position in which the clutch mechanism 70 is disengaged.

Moving the selection dial 132 to a third one of the settings represented by the numeral 2 on the selection dial 132 in FIGS. 7 and 9 causes, as illustrated in FIG. 15, the gear selection actuator 136 to actuate the gear selection ring 97 to the second position which corresponds to the second speed, or high speed, setting of the transmission assembly 30. Moving the selection dial 132 to the third one of the settings also causes the driven member mode selection actuator 138 to actuate the second member 167 to the second position which corresponds to the drive mode of the driven member 100. Moving the selection dial 132 to the third one of the positions also causes the torque control mode selection actuator 139 to move the key member 67 to the rearward position in which the clutch mechanism 70 is disengaged.

In a preferred form, in the first position of the selection dial 132 the driven member 100 is in either the drive mode or the adjustment mode, the clutch mechanism 70 is engaged and the transmission assembly 30 is in the first speed setting. In the first position of the selection dial 132 when the driven member 100 is in the adjustment mode operation of the motor 20 causes the driven member 100 to grip or release the working element 120. The first speed setting of the transmission assembly 30 is a low speed setting wherein the speed of rotation of the driven member 100 relative to the speed of rotation of the motor 20 is a relatively lower speed of the two speed settings of the transmission assembly 30. In the second position of the selection dial 132 the driven member 100 is adjusted to the drive mode and the gear selection actuator 136 and the gear selection ring 97 remain in the first position which corresponds to the first or low speed setting of the transmission assembly 30. In the third position of the selection dial 132 the driven member 100 remains in the drive mode and the gear selection actuator 136 actuates the gear selection ring 97 to the second position which corresponds to the second speed setting of the transmission assembly 30. The second speed setting of the transmission assembly 30 is a high speed setting wherein the speed of rotation of the driven member 100 relative to the speed of rotation of the motor 20 is relatively higher of the two speed settings of the transmission assembly

Hammer Mechanism

As illustrated in the Figures, the hammer mechanism 90 is disposed at the first end 61 of the second assembly 60 and includes the first hammer plate 91 and the second hammer plate 92. The first and second hammer plates 91, 92 each have a series of troughs and ridges which project along the direction of the axis Y-Y and which face towards each other in opposing relation. The first and second hammer plates 91, 92 are arranged concentrically around the drive shaft 60A. The second hammer plate 92 is fixed to the drive shaft 60A whereas the first hammer plate 91 which is locked relative to the housing 12 of the power tool 10 so as not to be able to rotate about the axis Y-Y.

When the hammer mechanism 90 is disengaged the second hammer plate 92 positioned away from and out of contact with the first hammer plate 91 When the hammer mechanism 90 is disengaged the second hammer plate 92 rotates in unison with the drive shaft 60A about the axis Y-Y without touching the first hammer plate 91. When the hammer mechanism 90 is disengaged the drive shaft 60A rotates freely relative to the first hammer plate 91. When the hammer mechanism 90 is engaged the second hammer plate 92 is allowed to move towards the first hammer plate 91 along with the drive shaft 60A. When the second hammer plate 92 is allowed to move towards the first hammer plate 91 the troughs and ridges of the first and second hammer plates 91, 92 interengage. When the drive shaft 60A rotates about the axis Y-Y and the first and second hammer plates 91, 92 rotate relative to each other the troughs and ridges of the first hammer plate 91 move over the troughs and ridges of the second hammer plate 92 which causes the drive shaft 60A and the driven member 100 to be displaced back and forth longitudinally relative to the first hammer plate 91 along the axis Y-Y. When the second hammer plate 92 is moved towards the first hammer plate 91 by the application of an axial force through the driven member and the drive shaft 60A in the direction of the axis Y-Y when a user applies the working element 120 gripped by the driven member 100 to a workpiece with a sufficient amount of force.

The invention has been described herein with reference to preferred embodiments. Modifications and alterations may occur to persons skilled in the art upon reading and understanding this specification. It is intended to include all such modifications and alterations insofar as they fall within the scope of the following claims or equivalents thereof.

1. A power tool including:
a rotatable driven member for releasably gripping and rotating a working element;
a transmission assembly for transmitting rotation from a motor to the driven member, the transmission assembly including a rotatable input shaft and first and second rotatable output shafts,
in a first speed setting the input shaft is selectively lockable together with the first output shaft so that the locked input shaft and first output shaft rotate in unison to drive rotation of the driven member at a first speed of rotation relative to a speed of rotation of the motor, and
in a second speed setting the input shaft is selectively lockable to the second output shaft so that the locked input shaft and second output shaft rotate in unison to drive rotation of the driven member at a second speed of rotation relative to the speed of rotation of the motor.

2. The power tool of claim 1, wherein the first output shaft includes a first output locking member, the second output shaft includes a second output locking member and the input shaft includes an input locking member, the output locking members are positioned adjacent each other and the input locking member is positioned concentrically around the output locking members so that the output locking members and the input locking member are coaxial, wherein the input locking member is selectively lockable together with either one of the output locking members.

3. The power tool of claim 2, wherein a selection member is positioned concentrically around the output locking member and is movable in the direction of an axis of rotation of the output locking members and the input locking member between a first position in which the selection member locks the input locking member together with the first output locking member of the first output shaft, and a second position in which the selection member locks the input locking member together with the second output locking member of the second output shaft.

4. The power tool of any one of the preceding claims, wherein one of the output shafts is positioned concentrically around at least a portion of the other one of the output shafts.

5. The power tool of any one of the preceding claims, wherein the input shaft and the first and second output shafts have a common axis of rotation.

6. The power tool of any one of the preceding claims, wherein the transmission assembly further includes a rotatable drive shaft which transmits rotation from one of the first and second rotatable output shafts to the driven member, wherein rotation of the drive shaft is directly driven by the first output shaft when the transmission is in the first speed setting and by the second output shaft when the transmission is in the second speed setting.

7. The power tool of claim 6, wherein the first and second output shafts respectively include first and second output gears and the drive shaft includes first and second drive shaft gears, wherein the first and second output gears are in constant meshing engagement with the first and second drive shaft gears respectively.

8. The power tool of claim 6 or claim 7, wherein the input shaft and the first and second output shafts have a common axis of rotation that is parallel to an axis of rotation of the drive shaft.

9. The power tool of any one of the preceding claims, further including a torque controller for controlling torque supplied from the motor to the driven member to render the driven member stationary when the amount of torque supplied from the motor to the driven member exceeds a pre-determined level.

10. The power tool of claim 9, wherein the torque controller includes a pair of opposing rotatable interlocking members which are biased towards each other with a force that causes the interlocking members to interlock when torque supplied by the motor to the driven member is less than the pre-determined level and to rotate relative to each other when the torque supplied by the motor to the driven member is greater than the pre-determined level.

11. The power tool of claim 10, wherein the opposing interlocking members each include successive ridges and grooves wherein the ridges and grooves of one of the members respectively interlock with the grooves and ridges of the other one of the members.

12. The power tool of claim 10 or 11, wherein the force biasing the interlocking members is adjustable so as to adjust the pre-determined level of torque.

13. The power tool of any one of claims 9 to 12, wherein the torque controller is only operable in the one of the first and second speed settings.

14. The power tool of any one of claims 9 to 13, further including a manual adjustment device for adjusting the pre-determined level of torque between a plurality of settings.

15. The power tool of any one of claims 9 to 14, wherein the torque controller is selectively operable or inoperable and the power tool further includes a switch mechanism for adjusting the transmission assembly between the first and second speed settings and for selecting between the operable and inoperable conditions of the torque controller.

16. The power tool of claim 15, wherein the switch is configured to adjust the transmission assembly to either the first or second speed setting when the torque controller is inoperable and to only one of the first and second speed settings when the torque controller is operable.

17. The power tool of any one of the preceding claims, wherein the driven member includes a drive mode and an adjustment mode, in the drive mode rotation of the driven member driven by the motor causes rotation of a working element gripped by the driven member and in the adjustment mode rotation of the driven member driven by the motor causes the driven member to grip or release the working element.

18. The power tool of claim 17, further including an adjustment mechanism for adjusting the driven member between the modes, the adjustment mechanism including first and second engagement portions that move into engagement with each other to thereby adjust the driven member to the adjustment mode and move out of engagement to thereby adjust the driven member to the drive mode.

19. The power tool of claim 18, wherein the first engagement portion is rotatable and the second engagement portion is not rotatable so that engagement between the first and second engagement portions prevents rotation of the first engagement portion.

20. The power tool of claim 19, wherein the first engagement portion is connected to a first threaded component which is in engagement with a second threaded component such that rotation of the second threaded component when the first engagement portion is prevented from rotating results in rotation of the first and second threaded components relative to each other and translational motion of the second threaded component.

21. The power tool of claim 20, wherein the second threaded component is a set of jaws for gripping the working element and the jaws are configured for translational motion towards each other to grip the working element and away from each other to release the working element.

22. The power tool of claims 17 to 21, further including a switch mechanism for adjusting the transmission assembly between the first and second speed settings and for adjusting the driven member between the adjustment and drive modes.

23. The power tool of claim 22, wherein the switch is configured to adjust the transmission assembly to either the first or second speed setting when the driven member is in the drive mode and to only one of the first and second speed settings when the driven member is in the adjustment mode.

24. A power tool including:
a rotatable driven member for releasably gripping and rotating a working element;
a transmission assembly for transmitting rotation from a motor to the driven member, the transmission assembly including a rotatable input shaft and first and second rotatable output shafts,
in a first speed setting the input shaft is selectively lockable together with the first output shaft so that the locked input shaft and first output shaft rotate in unison to drive rotation of the driven member at a first speed of rotation relative to a speed of rotation of the motor, and
in a second speed setting the input shaft is selectively lockable to the second output shaft so that the locked input shaft and second output shaft rotate in unison to drive rotation of the driven member at a second speed of rotation relative to the speed of rotation of the motor.
a torque controller operable for controlling torque supplied from the motor to the driven member to render the driven member stationary when the amount of torque supplied from the motor to the driven member exceeds a pre-determined level, and
a switch mechanism for adjusting the transmission assembly between the first and second speed settings and for rendering the torque controller operable or inoperable.

25. The power tool of claim 24, wherein the switch is operable for adjusting the transmission assembly between the first and second speed settings and for selecting between the operable and inoperable conditions of the torque controller in only one of the speed settings of the transmission assembly.

26. The power tool of claim 24 or claim 25, wherein the driven member includes a drive mode and an adjustment mode, in the drive mode rotation of the driven member causes rotation of a working element gripped by the driven member and in the adjustment mode rotation of the driven member driven by the motor causes the driven member to grip or release the working element,

27. The power tool of claim 26, wherein the switch is configured to adjust the transmission assembly to either the first or second speed setting when the driven member is in the drive mode and to only one of the first or second speed setting when the driven member is in the adjustment mode.

28. The power tool of any one of claims 24 to 27, further including a manual adjustment device for adjusting the pre-determined level of torque between a plurality of settings wherein at least one setting facilitates adjustment of the driven member by the switch to the adjustment mode and at least one setting prevents adjustment of the driven member by the switch to the adjustment mode and maintains the driven member in the drive mode.

29. The power tool of any one of the preceding claims, further including a hammer mechanism which can be engaged or disengaged, wherein when the hammer mechanism is engaged and rotation of the driven member is driven by the motor the driven member is displaced back and forth longitudinally along an axis of rotation of the driven member.

30. The power tool of any one of the preceding claims, wherein the motor is an alternating current powered motor.

31. A transmission assembly for use with a power tool including a rotatable driven member driven by a motor, the assembly including a rotatable input shaft and first and second rotatable output shafts,
in a first speed setting the input shaft is selectively lockable together with the first output shaft so that the locked input shaft and first output shaft rotate in unison to drive rotation of a driven member at a first speed of rotation relative to a speed of rotation of the motor, and
in a second speed setting the input shaft is selectively lockable to the second output shaft so that the locked input shaft and second output shaft rotate in unison to drive rotation of the driven member at a second speed of rotation relative to the speed of rotation of the motor.

32. The transmission assembly of claim 31, wherein the first output shaft includes a first output locking member, the second output shaft includes a second output locking member and the input shaft includes an input locking member, the output locking members are positioned adjacent each other and the input locking member is positioned concentrically around the output locking members so that the output locking members and the input locking member are coaxial, wherein the input locking member is selectively lockable together with either one of the output locking members.

33. The transmission assembly of claim 31 or claim 32, wherein a selection member is positioned concentrically around the output locking member and is movable in the direction of an axis of rotation of the output locking members and the input locking member between a first position in which the selection member locks the input locking member together with the first output locking member of the first output shaft, and a second position in which the selection member locks the input locking member together with the second output locking member of the second output shaft.

34. The transmission assembly of any one of claims 31 to 33, wherein one of the output shafts is positioned concentrically around at least a portion of the other one of the output shafts.

35. The transmission assembly of any one of claims 31 to 34, wherein the input shaft and the first and second output shafts have a common axis of rotation.

36. The transmission assembly of any one of claims 31 to 35, wherein the transmission assembly further includes a rotatable drive shaft which transmits rotation from one of the first and second rotatable output shafts to the driven member, wherein rotation of the drive shaft is directly driven by the first output shaft when the transmission is in the first speed setting and by the second output shaft when the transmission is in the second speed setting.

37. The transmission assembly of claim 36, wherein the first and second output shafts respectively include first and second output gears and the drive shaft includes first and second drive shaft gears, wherein the first and second output gears are in constant meshing engagement with the first and second drive shaft gears respectively.

38. The transmission assembly of claim 36 or claim 37, wherein the input shaft and the first and second output shafts have a common axis of rotation that is parallel to an axis of rotation of the drive shaft.

39. A switch mechanism for use in a device, the switch including a manually operated selector with three successive positions, wherein when the selector is in a first position a first actuator is biased towards a first position of the first actuator and a second actuator is biased towards a first position of the second actuator, when the selector is in a second position the first actuator is biased towards a second position of the first actuator and the second actuator is biased towards the first position of the second actuator, and when the selector is in a third position the first actuator is biased towards the second position of the first actuator and the second actuator is biased towards a second position of the second actuator.

40. The switch of claim 39, wherein movement of the selector between the first, second and third positions causes biased translation of the first and second actuators between their respective first and second positions.

41. The switch of claim 39 or claim 40, wherein when the first and second actuators are biased towards and reach either of their first and second positions the first and second actuators are locked in their respective first and second positions.

42. A torque controller for use with a power tool and operable for controlling torque transmitted from an input shaft to an output shaft, the torque controller including:
a pair of opposing rotatable interlocking members which are respectively mounted to one of the input and output shafts,
the opposing rotatable interlocking members are biased towards each other with a force that causes the interlocking members to interlock when torque supplied by the motor to the driven member is less than the pre-determined level and to rotate relative to each other when the torque supplied by the motor to the driven member is greater than the pre-determined level,
a mechanism for selectively rotatably locking and unlocking one of the interlocking members to one of the shafts for rendering the torque controller operable and inoperable respectively,
the mechanism including an intermediate member between the interlocking member and the shaft, wherein the intermediate member and the interlocking member are substantially rotatably locked together but are able to move longitudinally relative to each other in the direction of the axis of rotation.

43. The torque controller of claim 42, wherein the intermediate member is mounted to the shaft so as to be unable to move longitudinally relative to the shaft along the axis of rotation, and the interlocking member is mounted to the shaft so as to be able to move longitudinally relative to the shaft along the axis of rotation between a position interlocking with the other one of the interlocking members and a position not interlocking with the other one of the interlocking members in which the interlocking members are able to rotate relative to each other.

44. The torque controller of claim 42 or claim 43, wherein the intermediate member includes a slot with an opening extending longitudinally in the direction of the axis of rotation for receiving a projection of the interlocking member, the slot having a pair of opposing lateral sides for abutment with the projection to substantially prevent relative rotation of the intermediate member and the interlocking member, wherein longitudinal movement of the projection within opening of the slot enables the longitudinal movement of the intermediate member relative to the interlocking member in the direction of the axis of rotation.

45. The torque controller of claim 44, wherein the slot and the projection each have a substantially tapered profile and have substantially identical dimensions.

46. The torque controller of any one of claims 42 to 45, wherein the opposing interlocking members each include successive ridges and grooves wherein the ridges and grooves of one of the surfaces respectively interlock with the grooves and ridges of the other one of the members.

47. The torque controller of any one of claims 42 to 46, wherein the force biasing the interlocking members is adjustable so as to adjust the pre-determined level of torque.

48. The torque controller of any one of claims 42 to 47, further including a locking member rotatably fixed to the shaft and the intermediate member including an opening for receiving the locking member, wherein the locking member is configured to move longitudinally in alternate directions along the axis of rotation between a position in which the locking member is received within the opening and rotatably locks the intermediate member to the shaft and a position in which the locking member is not received within the opening and does not rotatably lock the intermediate member to the shaft.

49. The torque controller of any one of claims 42 to 48, wherein the intermediate member and the interlocking member include frictional contacting surfaces that provide frictional contact between the intermediate member and the interlocking member while the intermediate member and the interlocking member move longitudinally relative to each other in the direction of the axis of rotation.
